(19) United States
(12) Patent Application Publication
(10) Pub. No.: US 2008/0298941 A1
(43) Pub. Date: Dec. 4, 2008

(54) Charge Bucket Loading for Electric ARC Furnace Production

(76) Inventors: LeRoy G. Hagenbuch, Peoria, IL (US); Joshua J. Swank, Peoria, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/134,174

(22) Filed: Jun. 5, 2008

Related U.S. Application Data
(63) Continuation-in-part of application No. 11/945,117, filed on Nov. 26, 2007.
Application No. 11/945,117 is a continuation of application No. 10/374,803, filed on Feb. 25, 2003, now Pat. No. 7,326,023.
(60) Provisional application No. 60/942,185, filed on Jun. 5, 2007.
(60) Provisional application No. 60/943,031, filed on Jun. 8, 2007.

(51) Int. Cl. B60P 1/00

(52) U.S. Cl. 414/517

(57) ABSTRACT

Loads carried by a haulage vehicle are transferred from the vehicle to a container in a manner that maintains an ordered segmentation of materials comprising each of the loads, where each segment comprises a different type of material. The container receives the load such that each segment forms a layer in the container, which in the case of a charge bucket for feeding an electric arc furnace creates a layering of the different types of material according to a desired recipe for melting scrap metal processed by the mill incorporating the furnace. The transferring of the load is implemented by a haulage truck having a rear eject body whose ejector blade pushes the segmented load out and into the container.

### CROSS-REFERENCED TO RELATED APPLICATIONS

This patent application is a continuation-in-part of co-pending U.S. patent application Ser. No. 11/945,117, filed Nov. 26, 2007, which in turn is a continuation of U.S. patent application Ser. No. 10/374,803 filed Feb. 25, 2003 (now U.S. Pat. No. 7,326,023). Each of co-pending U.S. patent application Ser. No. 11/945,117 and U.S. Pat. No. 7,326,023 is hereby incorporated by reference into this application for everything it describes and teaches without exception.

This patent application also claims the benefit of U.S. Provisional Patent Application Nos. 60/942,185 and 60/943,031, filed Jun. 5 and 8, 2007, respectively, each of which is hereby incorporated by reference in its entirety for everything it describes and teaches without exception.

### FIELD OF THE INVENTION

This invention pertains to apparatus and methods for loading steel scrap metal into charge buckets servicing electric arc furnaces of steel mills.

### BACKGROUND OF THE INVENTION

For years electric arc furnace charge bucket loading has used a tried and true method with little change. Modern steel mini-mills require more efficient ways to load charge buckets that also more reliably provide the best quality steel scrap mix for providing the most cost effective and efficient steel making process.

The central factor to the best loading of charge buckets servicing electric arc furnaces is the correct layering of the steel scrap materials into the charge bucket. Proper layering of charge bucket material ensures that material is discharged into the electric arc furnace in a manner that results in the most efficient and fastest melt time with the least detriment to the electric arc furnace, leading to shorter “tap-to-tap” times, which is the time between the “tapping” of the contents of the electric arc furnace into a ladle and a subsequent tapping of the furnace after processing the next load of steel scrap delivered to the electric arc furnace by the charge bucket.

In the past, there have been several ways for getting steel scrap from the steel scrap yard to the charge bucket. Unfortunately, none of these ways provided both the best layering of the steel scrap metal in the charge bucket for efficient processing in the electric arc furnace and/or efficient mechanical loading of the steel scrap into the electric arc furnace to maintain the shortest “tap-to-tap” times. Three of these ways are briefly described here.

A. Rail Systems and Overhead Bridge Cranes

Probably the oldest yet still most prevalent way of getting steel scrap to the charge bucket is an in-plant railroad system that loads steel scrap into rail cars in a steel scrap yard. After each rail car is loaded with a particular type of steel scrap metal, it is positioned along side other rail cars loaded with other types of scrap metal on multiple side-by-side rail lines in a charging bay of the steel mill. In the charging bay, the steel scrap metal in each of the rail cars is transferred to the charging buckets using an overhead “bridge” crane that is equipped with a large electromagnet (“mag”) for picking up the steel scrap metal from the rail cars and depositing the steel scrap into the charge bucket. In this method, the charge bucket is mounted on a rail car called a “transfer car” and, when the charge bucket is filled, it is moved on the transfer car from the charging bay into an area adjacent the electric arc furnace called the “melt shop bay,” where the loaded charge bucket is picked up by a melt shop overhead bridge crane and discharged into the electric arc furnace.

Charge bucket bottoms are constructed in clam-shell halves hinged at the top of the charge buckets. They discharge their contents by opening from the bottom of the charge bucket, which causes the contents of the charge bucket to free fall into the electric arc furnace. Thus, the layering of steel scrap material into the charge bucket results in substantially the same layering in the electric arc furnace.

As long as the right materials are transported from the steel scrap yard to the charging bay by the several railroad cars, this method of loading the charge bucket has the advantage of enabling the correct layering of steel scrap into the charge bucket by selecting desired steel scrap types from the several rail cars as the charge bucket is loaded. When the contents of the loaded charge bucket are discharged or dropped into the electric arc furnace, with proper layering of material in the charge bucket minimal, if any, damage occurs to the furnace lining while also providing fast tap-to-tap melt times by layering the steel scrap to allow the electrodes of the electric arc furnace to more efficiently melt the steel scrap.

This method of loading the charge bucket can only proceed as fast as the overhead bridge cranes can “mag” steel scrap from the rail cars to the charge bucket. Also, the charge bucket layering recipes are limited to whatever steel scrap has been transported from the steel scrap yard to the charging bay by the rail cars. Furthermore, the charge bucket is loaded outside the area of the melt shop bay, which requires the charge bucket to be mounted on a transfer car to move the loaded charge bucket from the charging bay to the melt shop bay. All of this means the steel scrap has to be picked up and loaded twice; once in the scrap yard as the steel scrap is loaded into the rail cars, and a second time as the steel scrap is unloaded from the rail cars and loaded into the charging bucket.

Moreover, this method of loading the charge bucket is relatively equipment-intensive. Steel scrap yard loading equipment is required for loading the rail cars. A railroad system is required for moving the rail cars loaded with scrap steel from the scrap yard to the charging bay. Charging bay cranes (typically overhead bridge cranes) are required for transporting the steel scrap from the rail cars to the charge bucket. A transfer car and supporting rail system are required for moving the loaded charge bucket from the charging bay to the melt shop bay.

Loading the steel scrap twice to get it to the charge bucket is not only time consuming, but also expensive because it necessitates purchasing and maintaining two sets of steel scrap loading equipment—one set in the steel scrap yard where steel scrap is picked up and loaded in the rail cars and another set in the charging bay where steel scrap is unloaded from the rail cars and loaded into the charge bucket.

B. Movable Charge Bucket on a Transport System

A more recent development for loading charge buckets involves moving the charge bucket itself into the steel scrap yard so steel scrap can be loaded directly into the charge bucket. The charge bucket is transported to the steel scrap yard, either by a rubber tired charge bucket transporter or via a specially equipped rail car dedicated to hauling the charge buckets to and from the steel scrap yard.

Using this approach to loading the charge bucket, the steel scrap is only handled once in loading the charge bucket. Exactly the right recipe of steel scrap can be layered, in the desired order, into the charge bucket. After it is loaded, the charge bucket is moved directly to the melt shop bay via the charge bucket's transfer car, which carries the charge bucket to and from the steel scrap yard. There is no need for a separate transfer car between a charge bucket charging bay and the melt shop bay.

However, using this approach, a greater number of charge buckets are required. Charge bucket transporters or specially equipped rail cars are very large and unwieldy. Each charge bucket transporter must be capable of carrying both the charge bucket itself and the charge bucket load. The total weight of the transporter, the charge bucket and its steel scrap load is often in excess of several hundred tons. Charge bucket transporters are also highly specialized equipment requiring a substantial investment. A minimum of three (3) charge bucket transporters are required to assure substantially continuous charge bucket transporter operations.

The equipment in the scrap yard for loading the steel scrap into the charge bucket must be fairly substantial. It has to raise steel scrap up and over the top of a charge bucket whose height has been increased by being placed on the charge bucket transporter. The process of transporting the charge bucket from the steel mill to the scrap yard, loading of the charge bucket, and returning to the steel mill is a very slow and cumbersome process.

C. Dump Body Vehicles for Hauling Steel Scrap to the Charging Bay

Recently, off-highway trucks with dump bodies and on-board scales have been employed to haul steel scrap from the steel scrap yard to the charge bucket. In the steel scarp yard, off-highway trucks can be loaded with any number of different types of steel scrap and then driven directly to the mill where the steel scrap is dumped into charge buckets. The charge bucket is positioned either on a transfer car for subsequent movement into the melt shop bay or the charge bucket can be positioned directly in the melt shop bay.

A significant drawback to this off-highway truck haulage approach is the inability to control steel scrap layering in the charge bucket for subsequent discharge into the electric arc furnace. Even though the dump bodies can be loaded to provide different types of scrap material from front to back of the body, when dumped into the charge bucket the segmentation of the dump body load into different types of steel scrap material does not translate to a desired layering of the different types of steel scrap material in the charge bucket. Instead, the dumping action tends to churn the load and mix the different types of steel scrap material, thus losing the advantage of the careful segmentation achieved when loading the dump body in the scrap yard.

Another problem with using these vehicles to load the charge bucket is the substantial risk of damaging the charge bucket as steel scrap gains momentum as it slides out of the tilted dump body and impacts the charge bucket structure with significant force. There is also the additional safety concern. As steel scrap flows from a raised dump body, it is to a large degree totally uncontrolled. The steel scrap has a natural tendency to dump as one continuous homogenous mass as the steel scrap moves more or less as one in response to the pull of gravity as the dump body is tilted to dump its load, into the charge bucket. It is impossible to fine-tune the layering of steel scrap into the charge bucket. The momentum of material as it flows out of a rear dump truck body causes, in some cases, substantial charge bucket damage. Because the steel scrap falls in an uncontrolled manner from the dump body into the charge bucket, there also can be spillage of steel scrap around the charge bucket, requiring additional clean-up labor.

### BRIEF SUMMARY OF THE INVENTION

Segmented loads carried by a haulage vehicle are transferred from the vehicle to a container in a manner that maintains an ordered segmentation of materials comprising each of the loads, where each segment comprises a different type of material. The container receives the load such that each segment forms a layer in the container, which in the case of a charge bucket for feeding an electric arc furnace creates a layering of the different types of material according to a desired recipe for melting scrap metal processed by the mill incorporating the electric arc furnace.

In order to implement the transfer of a segmented load, a haulage vehicle having a rear eject haulage body is loaded with material of different types such that each type is a segment of the load that is adjacent to at least one other segment. Each segment, however, does not have another segment of a different type of material on top of it. The rear eject body is loaded so that the segment intended to form the bottom layer in the container is the segment at the back of the body. The segment intended to form the next layer in the container is positioned next to the segment at the end of the body. Additional segments arc added, working toward the front the body in the order of the intended layering for the segments in the container.

The rear eject body includes an ejector blade that pushes the segmented load from the front of the load toward an open rear of the body in order to unload the load from the body. Because the ejector blade pushes the load, the load tends to slide. Thus, there is little churning of the material comprising the load as it is moved and little resulting mixing of the segregated types of materials. As each segment reaches the open rear end of the rear ejector body as the ejector blade pushes the load, the load drops substantially vertically, which minimizes mixing at the junction between adjacent segments of different material comprising the load.

This process of transferring a segmented load to a container is most advantageously employed for loading charge buckets in a steel mill incorporating an electric arc furnace. Such an electric arc furnace operates best when the charge bucket is able to provide a layered load to the electric arc furnace in accordance with a desired recipe of different types of scrap metal taken from a scrap yard servicing the mill. By loading the rear eject body of a haulage vehicle in the scrap yard with segments of different types of scrap material required by the recipe and placing the segments comprising the load in the same order as the desired layering for the electric arc furnace, the transfer of the segmented load to the charge bucket by the pushing action of the ejector blade results in a well defined and desired layering of the load in the charge bucket. The charge bucket then simply drops the layered load into the electric arc furnace. Because the charge bucket opens from its bottom, the layering of the load in the charge bucket tends to stay cohesive as it drops into the electric arc furnace.

The haulage truck with the rear eject body preferably incorporates a weighing system that allows the operator of the truck and/or the operator of the machine loading the truck (e.g., a crane) to monitor the incremental increases in the weight as segments of different material are added to the load. The recipes for the electric arc furnaces require a knowledge of the total weight of the load and therefore, also a knowledge of the weight of each segment in order to provide the best proportions for the desired charge bucket layering to be fed to the electric arc furnace.

The ejector blade of the rear eject body cooperates with a tailgate of the body during the process of ejecting the load. When the ejector blade begins to eject a load, the tailgate is transferred from its closed position to an open position, exposing an open end of the body so that the segments of the load drop off the edge of the floor of the body as the ejector blade pushes the load rearward.

Because the truck with a rear eject body does not need to elevate the body to dump the load, the rear eject truck body in ejecting the load can clear overhead areas of the mill that make the process of loading the charge bucket amenable to occurring within the melt shop of the mill. By loading the charge bucket within the melt shop, there is no need for the expense of maintaining a transport machine to move the charge bucket outside the melt shop for loading. Of course, the truck with the rear eject body can load the charge bucket outside of the melt shop as well. In either case, the truck is positioned so that the floor of the rear eject body is above the lip of the charge bucket in order for the segments of material to drop directly into the charge bucket. This relative elevation can be achieved by either employing a ramp for the truck to use to position itself above the ground grade supporting the charge bucket or the charge bucket can be placed in a pit while the truck stays at ground grade.

### BRIEF DESCRIPTION OF THE DRAWINGS

FIG. 1 is a diagram representing an exemplary layout of a steel scrap yard in which steel scrap for melting is sorted by various types.

FIGS. 2 and 3 are side views of a rear eject hauler for hauling steel scrap collected from the steel scrap yard of FIG. 1 as it is being loaded by a crane equipped with a grapple (FIG. 2) or a magnet (FIG. 3);

FIG. 4 is a side view of the rear eject hauler of FIGS. 2 and 3 with its body fully loaded with steel scrap from the steel scrap yard such that the load is segmented by types of steel scrap material front to back;

FIG. 5 is a side view of the rear eject hauler of FIGS. 2-4 positioned to eject its segmented load into a charge bucket;

FIGS. 6-9 are side views of the rear eject hauler of FIGS. 2-5, showing a tailgate of the hauler's body opened and an ejector blade in the body moving rearward to eject the load of steel scrap into the charge bucket, causing the segmented load to fall into the charge bucket substantially one segment at a time with minimal amounts of mixing among the different steel scrap segments in the charge bucket;

FIG. 10 is a side view of the fully loaded charge bucket of FIGS. 5-9, illustrating how the segmented types of steel scrap comprising the load carried in the truck body are transformed to a layering or stacking of the different types of steel scrap in the charge bucket with minimal disruption of their segregation created during the loading process;

FIG. 11 illustrates an exploded perspective view of an exemplary truck frame supporting a stationary body of a type suitable for hauling steel scrap metal to the charge bucket (the ejector assembly is not shown) and incorporating an on-board weighing system for accurately measuring the correct amount of each type of steel scrap metal loaded into the body of the rear eject hauler, thereby assisting in creating the correct recipe of steel scrap metal types to load into the charge bucket;

FIGS. 12 (a) through (g) are schematic top plan views of a melt shop bay of an exemplary steel mill in which electric arc furnaces are used to melt steel scrap brought from the scrap yard of FIG. 1, each of the drawings (a) through (g) illustrating a snapshot in a time sequence starting with the rear eject hauler of FIG. 5 beginning to eject steel scrap loaded from the steel scrap yard into the charge bucket and ending with the steel scrap loaded into the furnace, wherein the charge bucket is positioned within the melt shop;

FIGS. 13 (a) through (h) are schematic top plan views of an alternative configuration of the melt shop bay of the exemplary steel mill of FIGS. 12 (a) through (g) in which the charge bucket is transported outside the melt shop bay to a charging bay area adjacent the melt shop, each of the drawings (a) through (h) illustrating a snapshot in a time sequence starting with the rear eject hauler of FIG. 5 beginning to eject steel scrap loaded from the steel scrap yard of FIG. 1 into a charge bucket in a charging bay and ending with the steel scrap loaded into the electric arc furnace, where the charge bucket is loaded in the charging bay outside the melt shop;

FIGS. 14-27 illustrate details of a preferred body for the rear ejector hauler of FIGS. 1-13 for ejecting a load of steel scrap as illustrated in FIGS. 1-13;

FIG. 14 is a side view of an articulated off-highway truck having an exemplary rear eject body constructed in accordance with the present invention showing the ejector blade retracted and the tailgate closed;

FIG. 15 is a rear view of the truck and rear eject body of FIG. 14 showing the ejector blade retracted and the tailgate closed;

FIG. 16 is a side view of the truck and rear eject body of FIG. 14 showing the ejector blade extended and the tailgate open;

FIG. 17 is a rear view of the truck and rear eject body of FIG. 15 showing the ejector blade extended and the tailgate open;

FIG. 18 is a perspective view of the rear eject body of FIG. 14 showing the ejector blade retracted and the tailgate closed;

FIG. 19 is a perspective view of the rear eject body of FIG. 14 showing the ejector blade extended and the tailgate open;

FIG. 20 is a front view of the rear eject body of FIG. 14;

FIG. 21 is a front perspective view of the rear eject body of FIG. 14 showing the ejector blade extended and the tailgate open;

FIG. 22 is an enlarged partial end view of the rear eject body of FIG. 14 showing one of the ejector blade guide tracks/slides;

FIG. 23 is an enlarged partial end view of the rear eject body of FIG. 14 showing one of the ejector blade guide tracks and one of the ejector blade sleds with the ejector blade cutaway;

FIG. 24 is an enlarged partial side view of a rear eject body of FIG. 14 showing the tailgate in the closed position;

FIG. 25 is an enlarged partial side view of the rear eject body of FIGS. 14 and 24 showing the tailgate in the nearly open position; and

FIGS. 26 and 27 are enlarged and partial front perspective views (different angles) of the rear eject body of FIG. 14, showing the hydraulic cylinder mounting arrangement.

### DETAILED DESCRIPTION OF THE INVENTION

In keeping with the invention, rear eject bodies of the type illustrated and described in U.S. Pat. No. 7,326,023 are described in detail herein. U.S. Pat. No. 7,326,023 is hereby incorporated by reference for everything it describes and teaches. These types of haulage bodies as distinguished from other types of haulage bodies such as those commonly called “dump bodies” that pivot about a hinge in order to elevate the body, allowing gravity to work to dump the load it from the body. Rear eject haulage bodies of the type used in the invention do not raise the bodies to discharge the loads. Instead, a rear eject body depends on an ejector assembly that pushes the load from the front of the body toward the rear. The load falls from the body's rear edge as the ejector assembly continues to push the load toward the back edge of the body. When the ejector assembly reaches the rear end of the body, the load has been completely discharged. The ejector assembly then returns to a position in the forward area of the body and the body is then ready to be re-loaded.

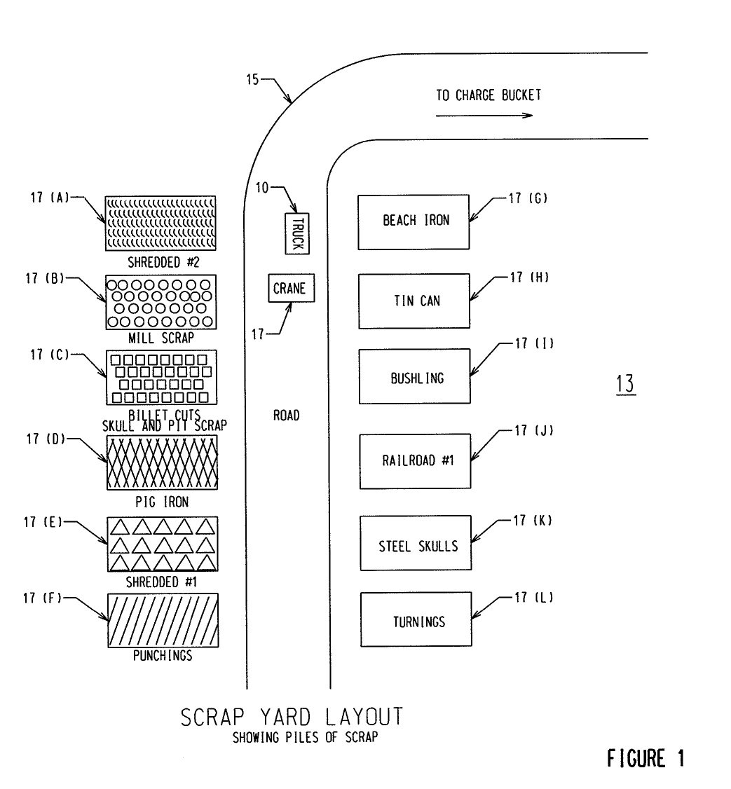

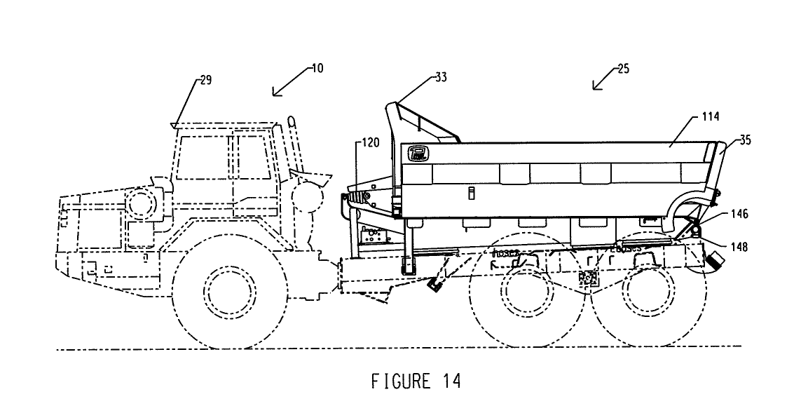

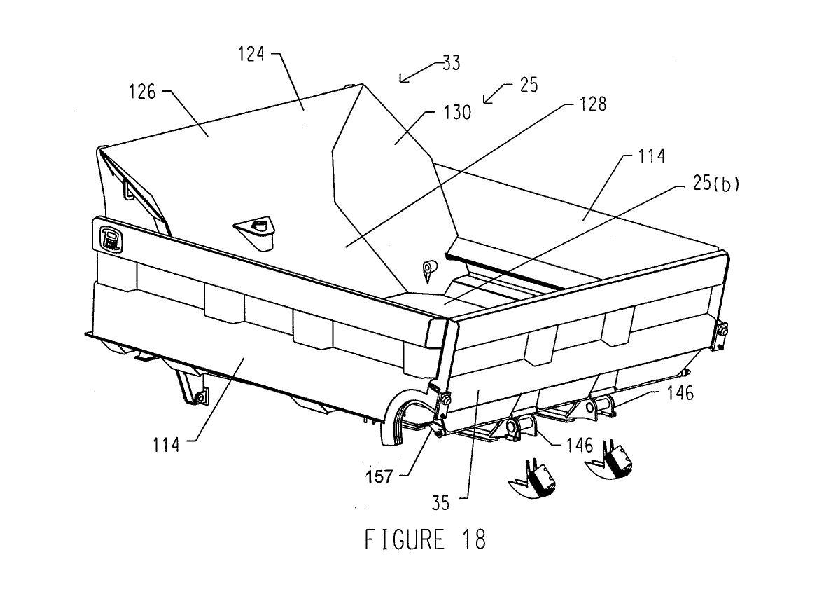

A specific vehicle with a rear eject body is described and illustrated in FIGS. 14-27 hereinafter. Additional detail of this vehicle can be found in the above-identified U.S. Pat. No. 7,326,023. A more generally illustrated vehicle 10 with a rear eject body is illustrated in FIGS. 1-13. The truck 10 is illustrated transporting steel scrap material, such as steel scrap metal of different types, from a steel scrap yard to a charge bucket of a steel processing mill. The steel scrap metal is loaded into the charge bucket, moved to an electric arc furnace and melted therein, relying on a high-energy electrical charge passing through the steel scrap material. In order to best melt and prepare the steel scrap metal for processing, different types of steel scrap metal are loaded into the charge bucket in layers. By loading the charge bucket with a rear eject haulage body, the segmentation of the load into different types of the steel scrap metal created during the loading of the truck 10 is retained when the load is ejected from the truck 10 into the charge bucket. The charge bucket then drops the load into the electric arc furnace in a manner that substantially maintains the segmentation or segregation of the material in the load. Therefore, by loading the truck 10 in a manner that segregates types of steel scrap in accordance with the order of a desired layering for the charge bucket, the transfer of the material from the truck to the charge bucket results in the intended layering of the load.

Generally, as shown in the example layout of FIG. 1, different types and sizes of steel scrap material are separated into different piles at a steel scrap yard for processing. The steel scrap yard 13 is typically in the same vicinity as the mill that processes the steel scrap into new steel. In FIG. 1, a roadway 15 runs through the steel scrap yard 13. The processing of the steel scrap metal includes loading the steel scrap into a charge bucket, which then carries the steel scrap material to an electric arc furnace where a high energy electric charge is applied to melt the scrap. The melted steel scrap metal is then “tapped” from the furnace for further processing that results in new steel products—e.g., coils of flat steel or structural members such as “I” beams for use in producing various products.

The process of making steel from steel scrap begins by loading the steel scrap material into the truck 10 in FIG. 1. A crane 17 loads the truck with the steel scrap and, in keeping with the invention, segregates the types of steel scrap along the length of the body. In this regard, a typical steel scrap yard has the steel scrap material sorted into different types or categories of material. FIG. 1 illustrates how the steel scrap may be segregated by way of example and not limitation.

Large amounts of electrical energy are required to melt the steel scrap metal. In this regard, it is desirable to load the charge bucket in a manner that minimizes the amount of energy used to melt the steel scrap material. This is accomplished, for example, by generally placing different types of steel scrap material into separate layers within the charge bucket—e.g., the most conductive steel scrap at the top and/or bottom of the charge bucket. In other situations, it may be desirable to place large steel scrap items near the middle of the charge bucket and smaller steel scrap items near the top of the charge bucket in order to enhance electrical conductivity of the entire load of steel scrap metal in the bucket. Often, the steel scrap is layered to reduce the potential for damage and the amount of wear experienced by the charge bucket and the electric arc furnace. For example, the charge bucket may first be filled by softer material or material of lesser density.

The charge bucket is usually disposed at a location remote from the piles of steel scrap material at the steel scrap yard in FIG. 1, and the rear eject truck 10 transports the steel scrap material from the steel scrap yard 13 to the charge bucket. The rear eject body of the truck 10 enables a method of loading a charge bucket with a quantity of steel scrap material in a generally organized manner and without losing the organization given it during the loading in the steel scrap yard of the steel scrap into the truck.

The illustrated steel scrap yard 13 is organized such that steel scrap material of different types is collected in piles 17 (a) through 17 (l), which are generally shown to be on both sides of the roadway 15 to enable easy access by the crane 17. Each pile 17 (a)-17 (l) of steel scrap metal is a different type of metal. The truck 10 travels along the roadway 15 and stops at various stations associated with piles of types of steel scrap metal. At each stop, the truck 10 is loaded with a type of steel scrap. Each type of steel scrap is loaded into the truck body so it is adjacent to and not on top of other types of steel scrap material loaded at a different station. In this regard, the yard 13 may have multiple cranes 17 stationed around the steel scrap yard to load the truck 10 or it may be that the crane 17 moves to the different piles with or without complementary movement of the truck.

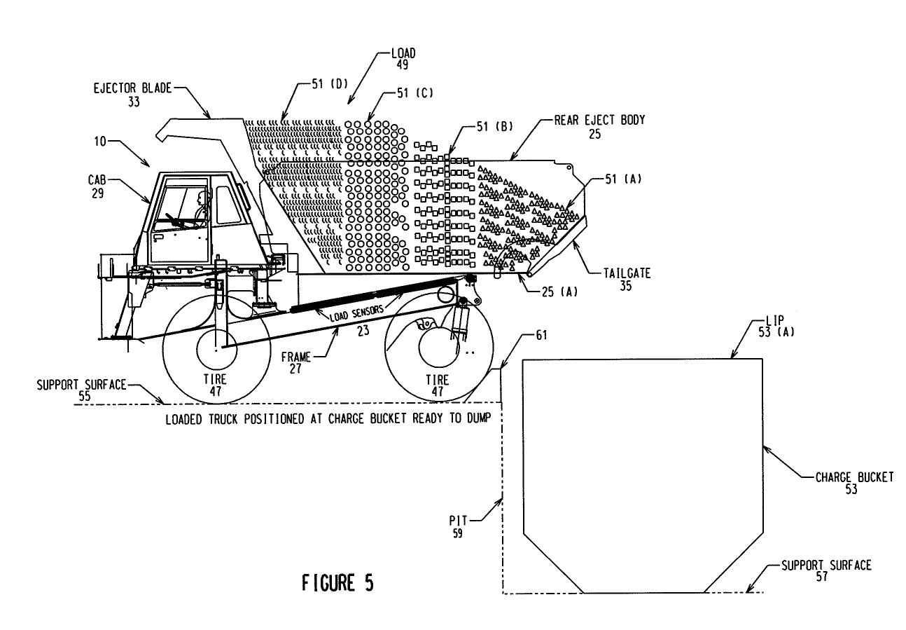

In FIG. 1, several different types of steel scrap are illustrated. These illustrated types are shown by way of example and not limitation because many different types or categories of steel scrap can be identified and the steel scrap metal segregated accordingly in the yard 13. In FIG. 1, two types of shredded steel scrap metal are illustrated, marked as “#1” and “#2” and placed in piles 17 (e) and 17 (a), respectively. The shredded steel scrap metal #2 has a finer granulation than does shredded steel scrap metal #1. Other types of steel scrap metal illustrated in FIG. 1 are mill scrap 17 (b), billet cuts and skull and pit scrap 17 (c), pig iron scrap 17 (d) and punching scrap 17 (f). Each of these is illustrated in a representative box in FIG. 1 using a visual pattern different from the other types of steel scrap. These same visual patterns are used in FIGS. 5-10 to illustrate the segmentation or segregation of the load by the different types of steel scrap metal in the rear eject body of the truck 10 and in the layering of the different types of steel scrap when the load is transferred to the charge bucket. Other types of steel scrap metal are illustrated in the steel scrap yard of FIG. 1, including beach iron scrap 17 (g), tin can scrap 17 (h), bushling scrap 17 (i), railroad scrap 17 (j), steel skull scrap 17 (k) and turnings scrap 17 (l). Because these steel scraps are not used in the exemplary loading of the truck in FIGS. 5-9, however, FIG. 1 does not assign a visual pattern to each of these additional types of steel scrap. However, the reader will appreciate that these types of steel scraps are also contemplated to be included in a segmented or segregated loading of the truck as illustrated in FIGS. 5-9.

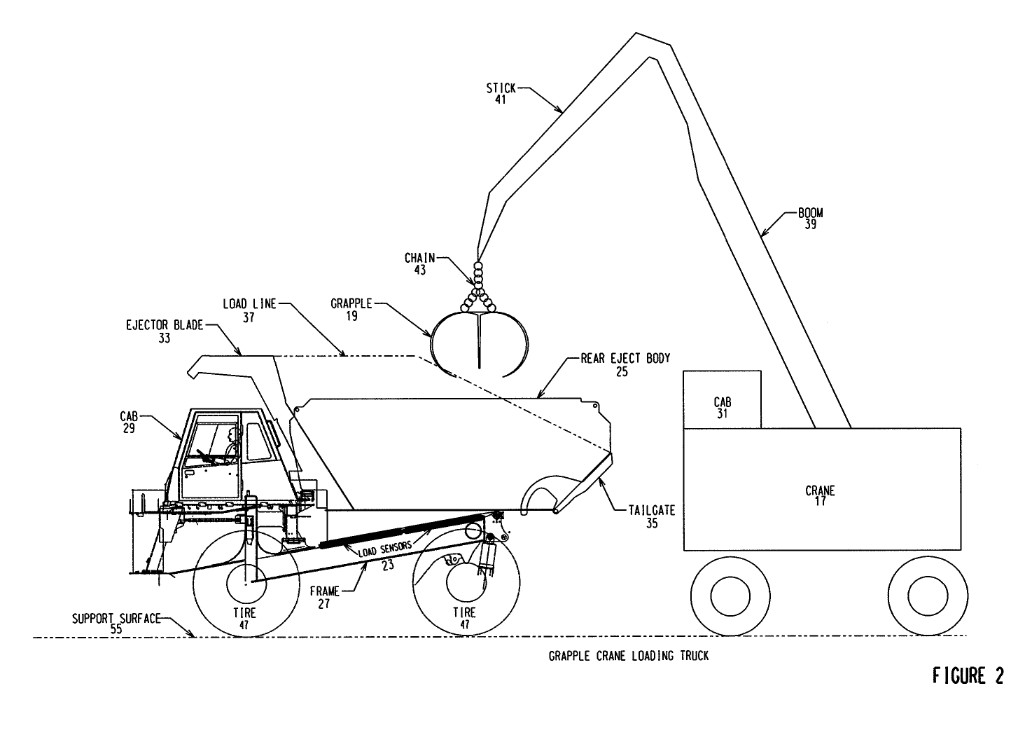

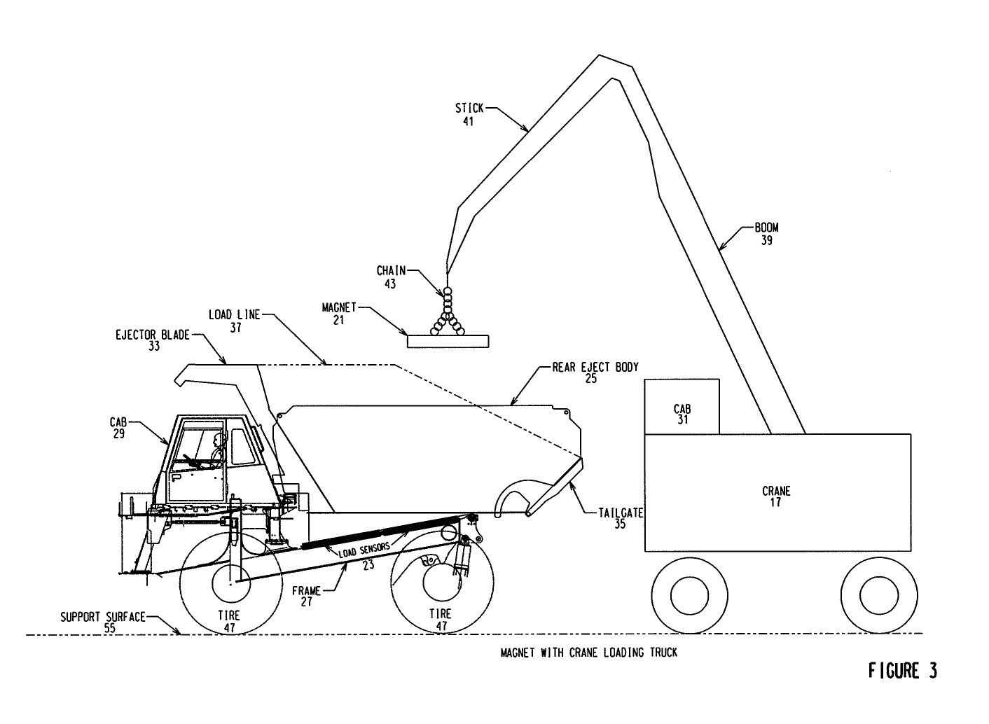

Large amounts of steel scrap material are retrieved from the steel scrap piles 17 (a)-17(l) by the crane 17 or other suitable equipment as illustrated in FIGS. 1, 2 and 3. The crane 17 loads the rear eject body either from front to back or from back to front with different types of steel scrap metal selected from the piles 17(a)-17(l). Each crane 17 may have any suitable attachment for moving steel scrap material from one of the piles 17 (a)-17(l) into the truck 10. For example, turning to FIG. 2, in some embodiments the crane 17 may include a grapple 19 for picking up steel scrap material and placing it in the truck. In other embodiments, such as shown in FIG. 3, a magnet attachment 21 may be used for picking up steel scrap material and placing it in the truck 10. The magnet 21 may be particularly useful for picking up steel scrap material that is too small to lift with a grapple—e.g., the shredded scrap #2.

The truck 10 preferably incorporates on-board weighing load sensors 23 for detecting and monitoring various loading conditions associated with the rear eject body 25 of the truck 10. For example, the load sensors 23 may be disposed on a frame 27 of the truck 10 as shown in FIGS. 2-9. These load sensors 23 are incorporated into a weighing system that is described in connection with FIG. 11 hereinafter. The load sensors 23 detect any suitable load conditions including, but not limited to, how much of each type of steel scrap material has been placed into the rear eject body and when the rear eject body is full. Examples of suitable sensors, sensor operations, sensor placement, sensor data management, etc., for use in the embodiments disclosed herein are found in U.S. Pat. No. 5,416,706, which is hereby incorporated by reference in its entirety and for everything that it describes and teaches without exception. For example, the '706 patent describes providing weight information to both the operator of the truck 10 and the operator of the crane 17. A display (not shown) in the cabs 29 and 31 of the truck 10 and crane 17, respectively, enable the truck and crane operators to load the rear eject body 25 to a precise weight that best matches the desired weight of the load to be placed into the charge bucket.

The load sensors 23 fit at the interface of the rear eject body 25 and the frame of the truck 10. FIG. 2 of the '706 patent illustrates a fixed body (i.e., not a rotatable or “dump” body as illustrated in FIGS. 1a and 1b of the '706 patent). FIG. 2 of the '706 patent is reproduced herein as FIG. 11. Because the rear eject body 25 is also a fixed body, the load sensors in FIG. 11 are the most applicable to the rear eject body. It will be appreciated, however, that other known types and configurations of weight sensors for determining the weight of a load carried by a haulage vehicle may be substituted for the weighing device of the '706 patent.

In FIGS. 2 and 3, the rear eject body 25 has an ejector blade 33 positioned at the front of the body as illustrated when the body is being loaded by the crane 17. During loading of the body 25 of the truck 10, a tailgate 35 is in a closed position as illustrated in FIGS. 2 and 3. A dashed load line 37 illustrates the profile of a load of steel scrap material carried by the body 25. In both FIGS. 2 and 3, the crane 17 has a boom 39 supporting a stick 41, which in turn supports a chain 43 connected to either the grapple 19 in FIG. 2 or the magnet 21 in FIG. 3. Of course, the truck 10 is supported by the ground 55 by tires 47. Likewise, the crane is supported by tires as illustrated or tracks.

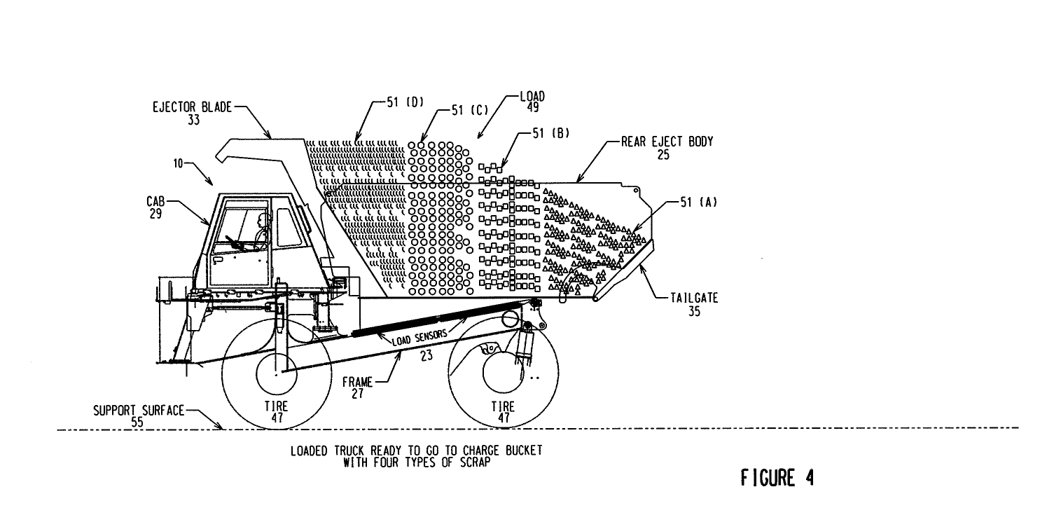

FIG. 4 shows a load 49 of steel scrap metal carried by the truck 10 that has been created by loading different types of steel scrap such that the types are separated into segments along the length of the rear eject body, with each segment in contact with another segment of a different type of steel scrap on one or both sides of the segment, but the segment does not have any other type of material layered over it. By way of example, and not limitation, the rear eject body 25 of the truck 10 in FIG. 4 is loaded to have four segments 51 (a) through 51 (d) of different types of steel scrap material from the steel scrap yard 13 in FIG. 1. The first segment 51 (a) comprises the large shredded scrap #1 and is loaded by the crane 17 to be near the tailgate. Working forward, a segment 51 (b) of billet cuts is added next by the crane 17, followed by a segment 51 (c) of mill scraps, and finally a segment 51 (d) of shredded scraps #2 is added near the ejector blade 33. This order of segmenting or segregating the load 49 is in keeping with a recipe a steel mill may desire for the order of different types of steel scrap metal in a layering of steel scrap types in the charge bucket. However, any order of the segments in the load 49 may be made as desired and any number of segments may be created, subject to the physical limitations of the rear eject body 25. Steel mills have found that certain recipes for layering the steel scrap metal into the charge bucket can reduce the energy requirement for melting the steel scrap, can minimize the damage caused to the charge bucket and the electric arc furnace from the impact of the steel scrap as it moves substantially as an aggregate from the truck to the charge bucket and then from the charge bucket to the electric arc furnace, and also shorten electric arc furnace tap-to-tap times. Thus, the crane 17 loads the rear eject body 25 to create a segmenting of the steel scrap material by steel scrap type as illustrated so that when it is ejected from the rear eject body it in effect is turned 90 degrees to form a desired layering or “recipe” of the steel scrap metal in the charge bucket, which then in turn provides the desired layering when the charge bucket releases the load into the electric arc furnace for melting.

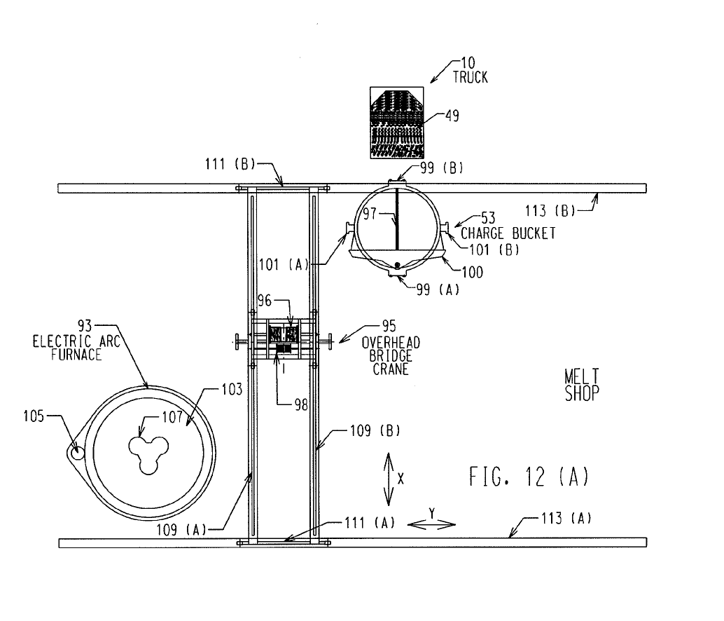

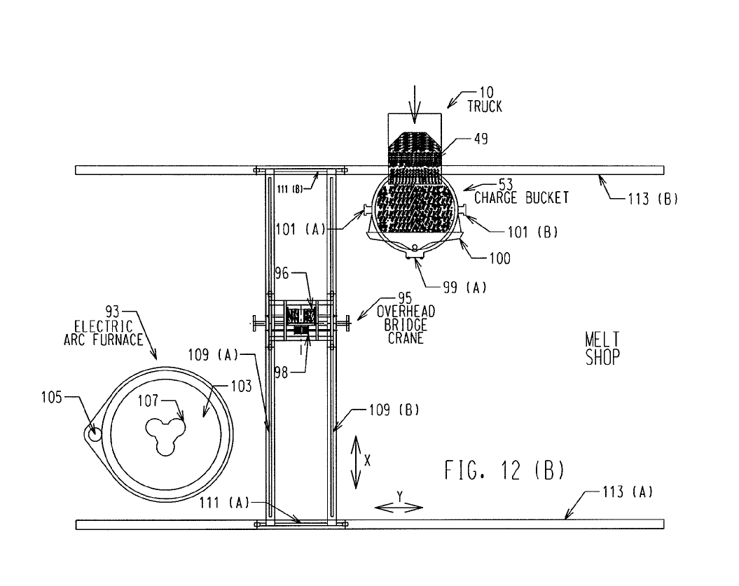

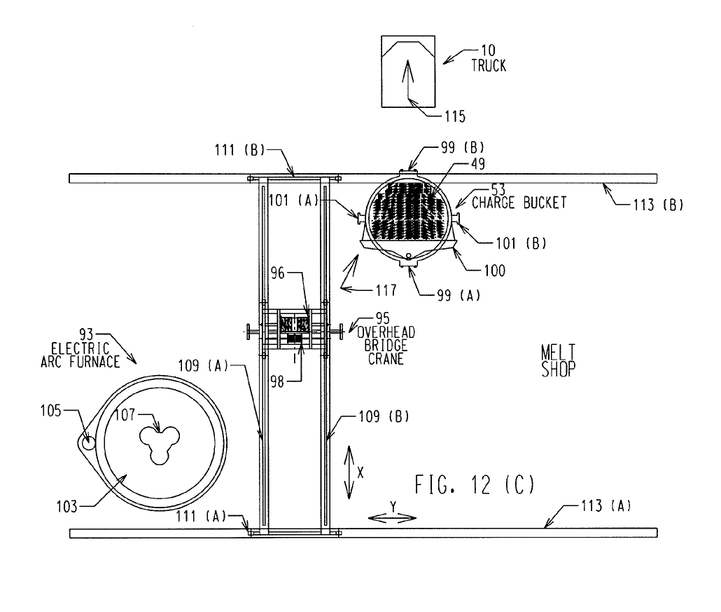

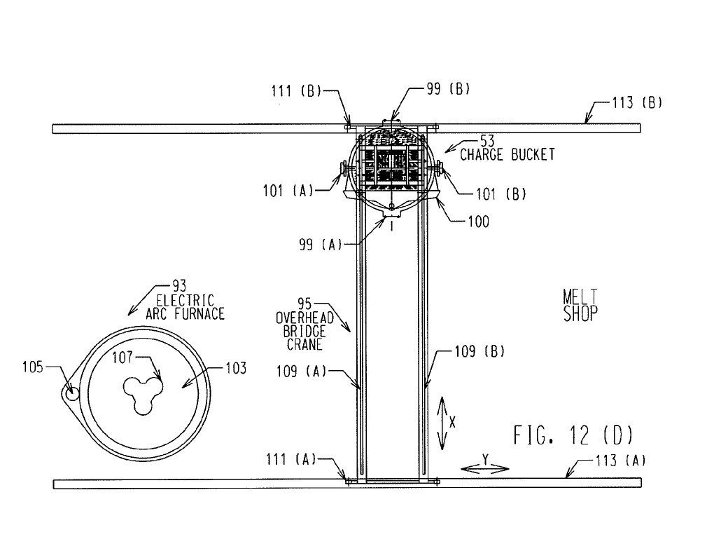

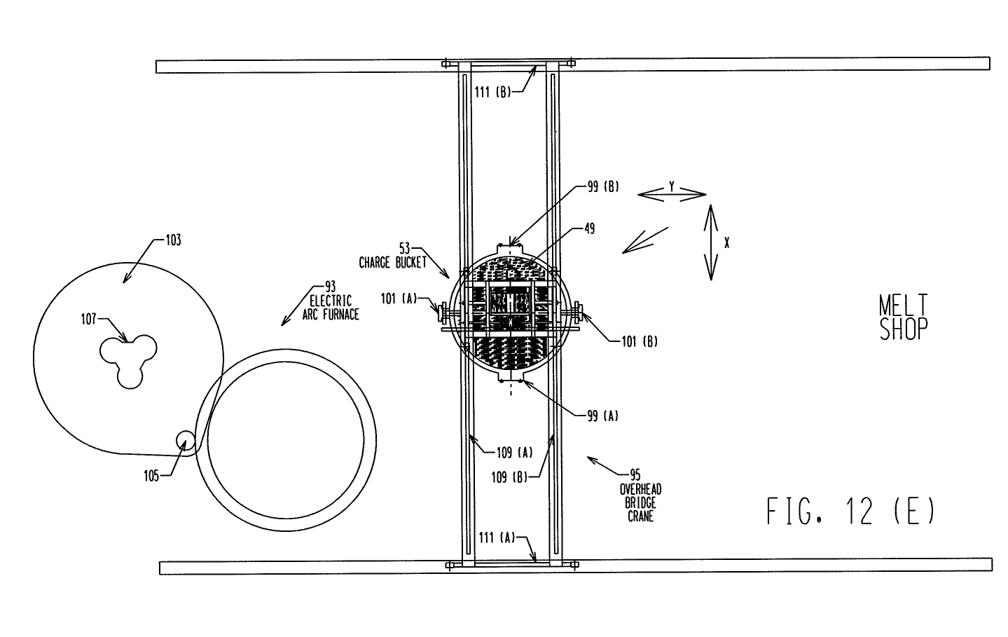

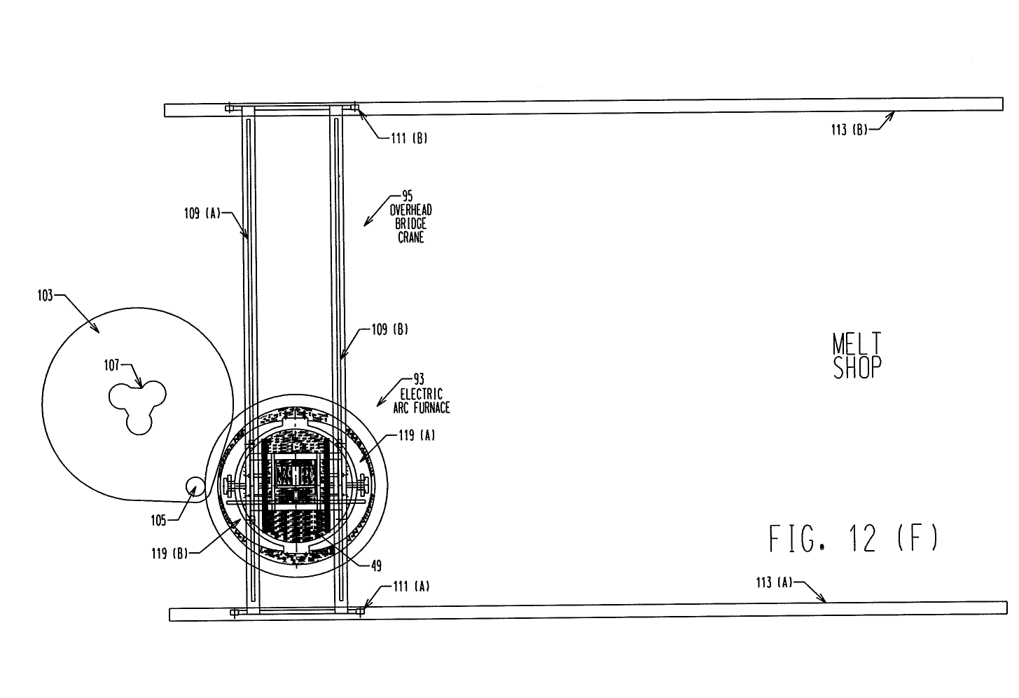

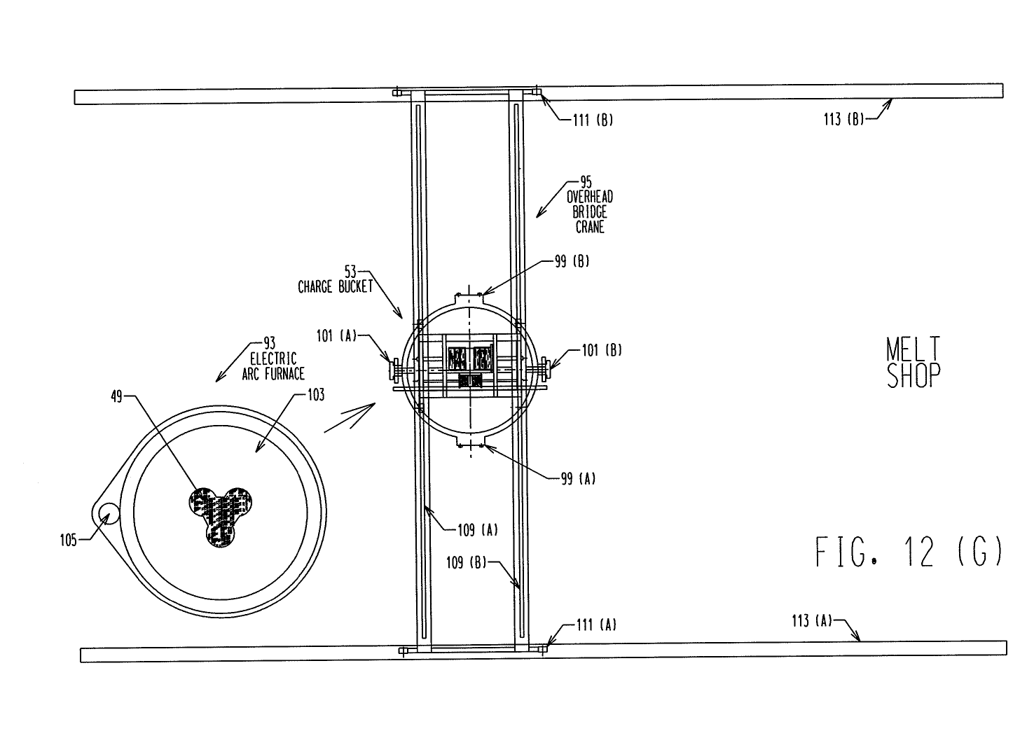

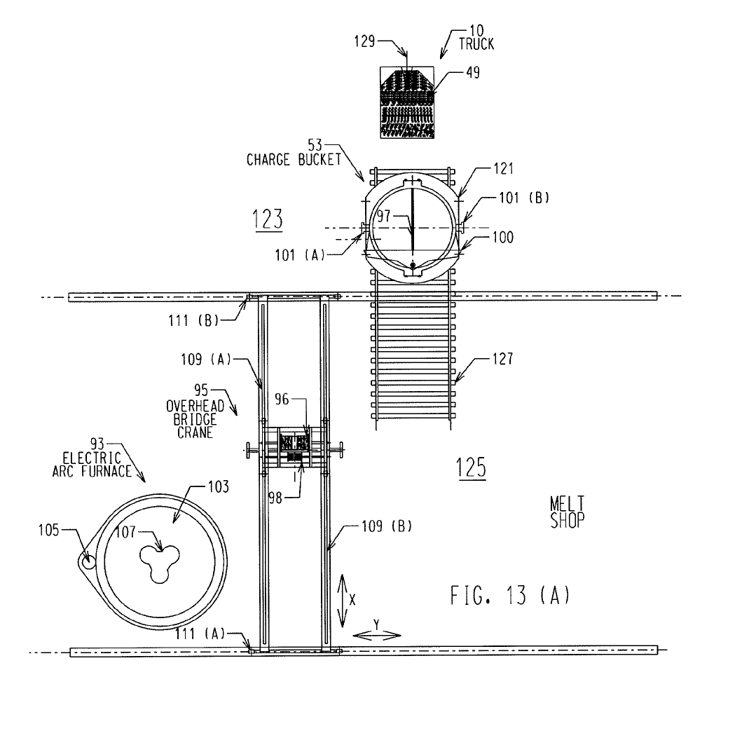

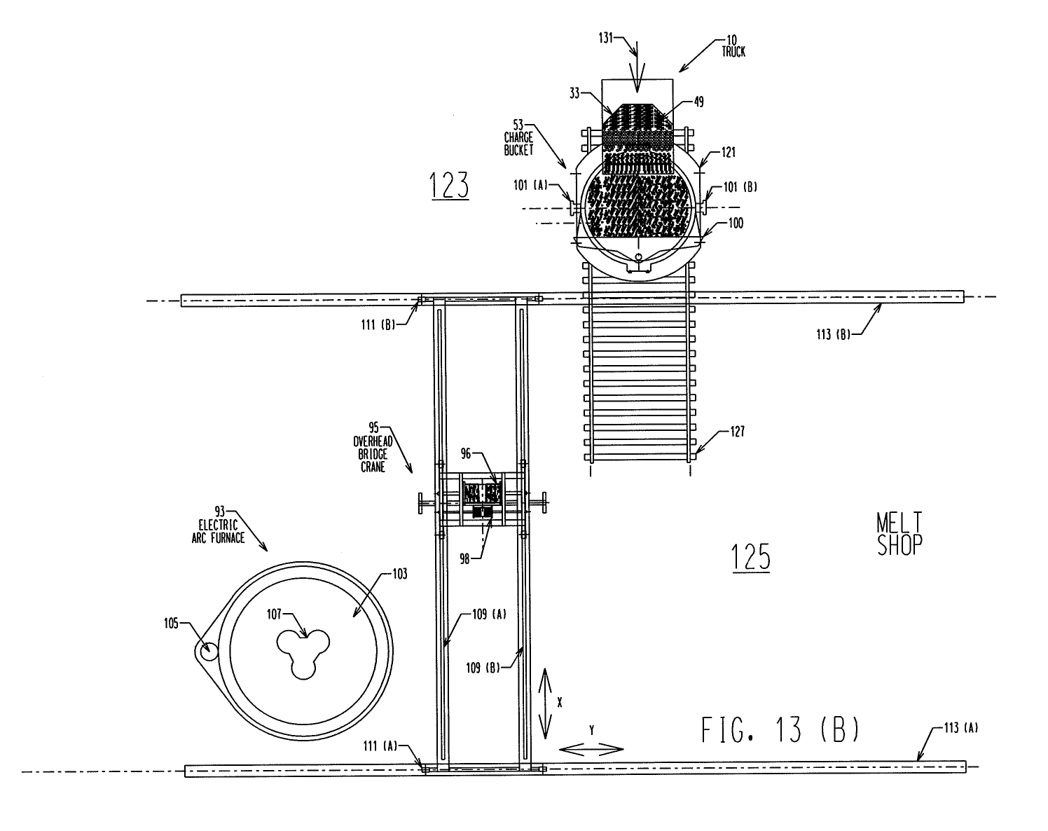

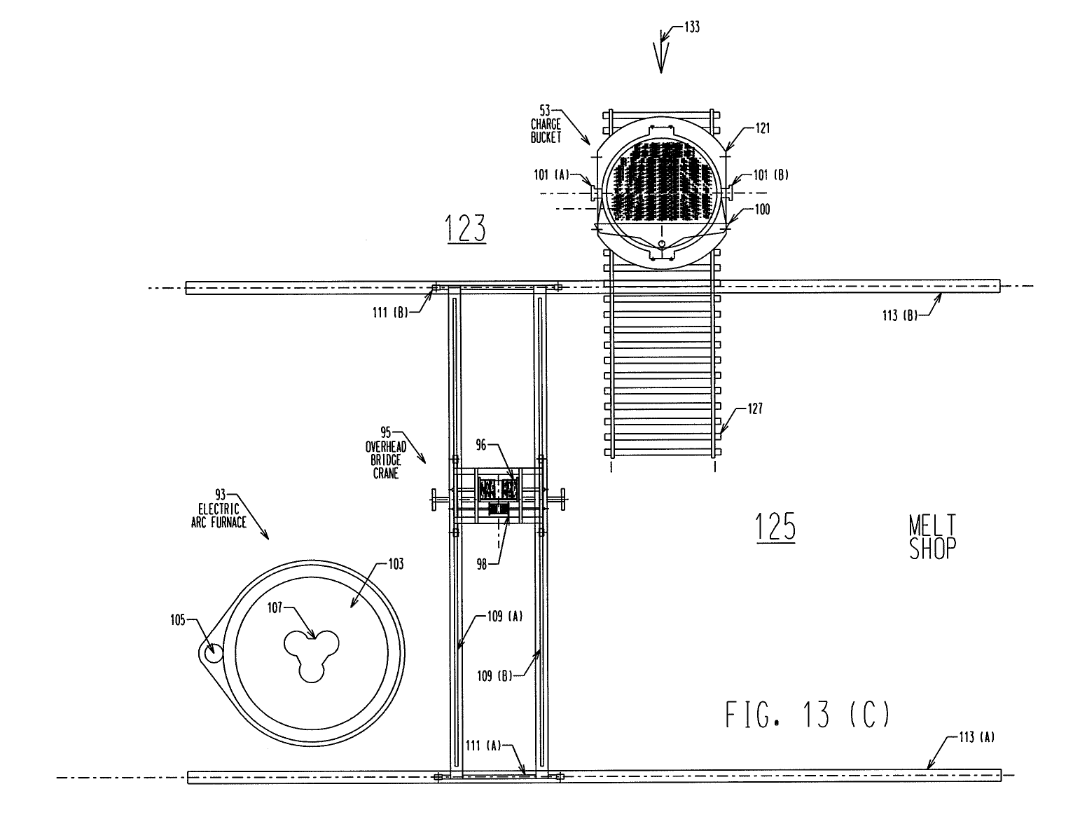

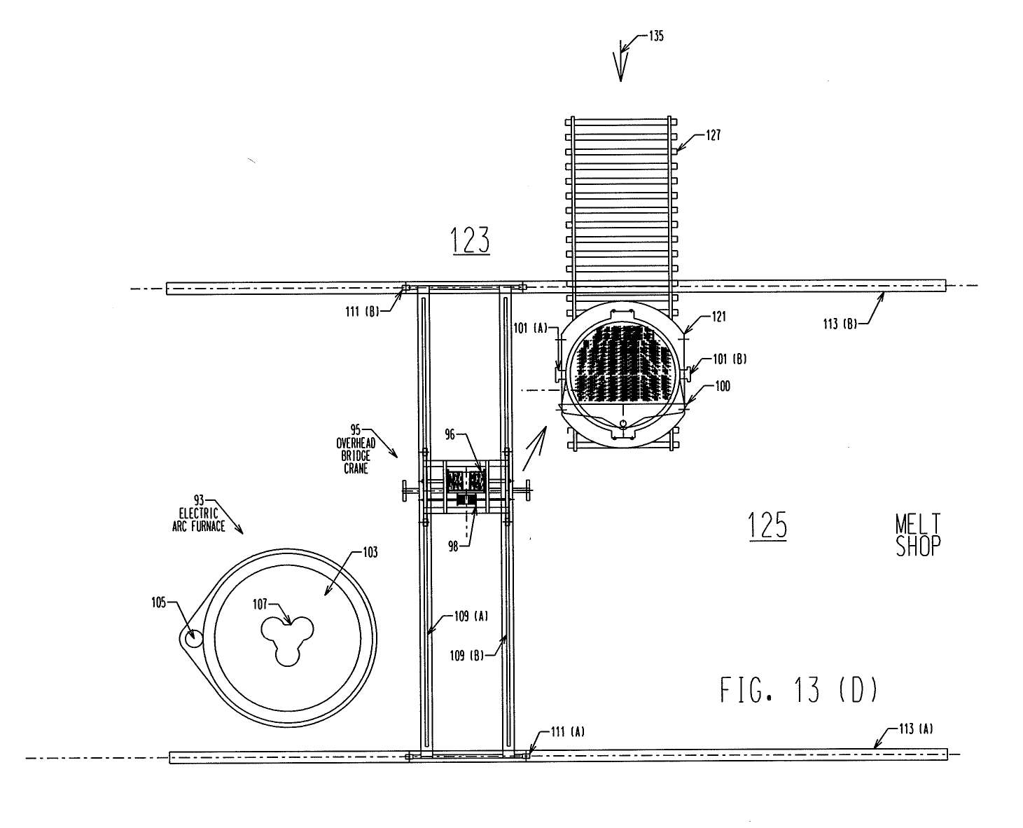

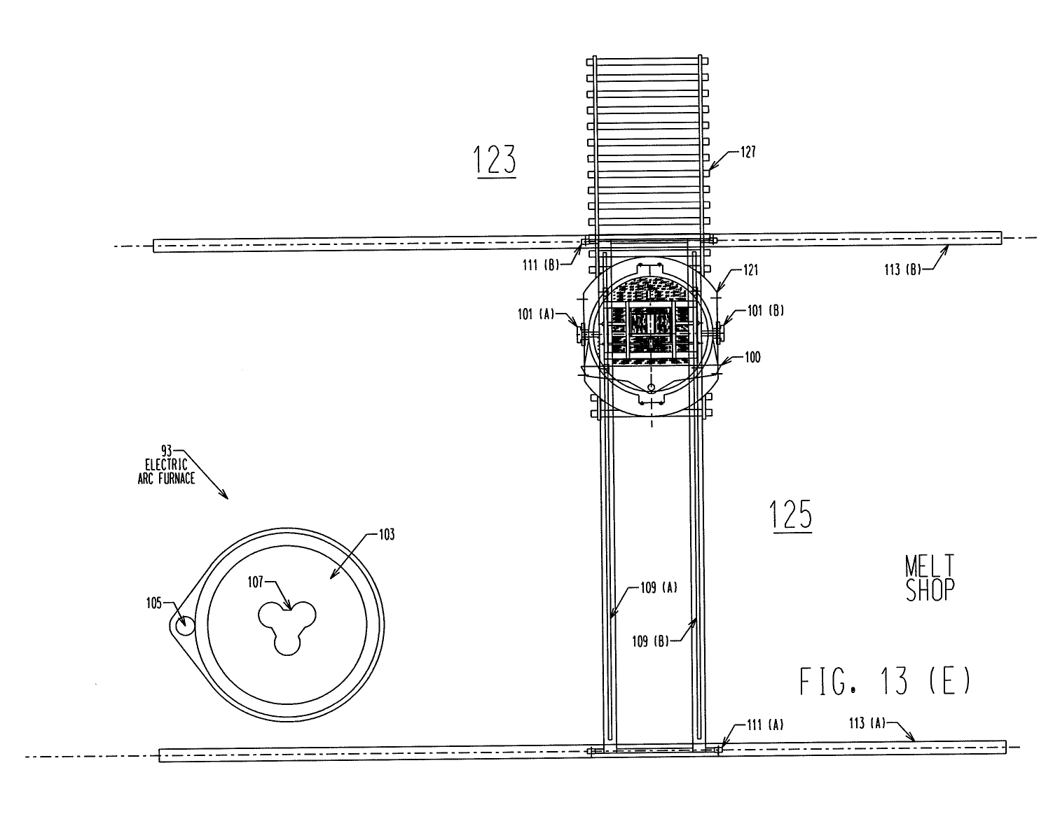

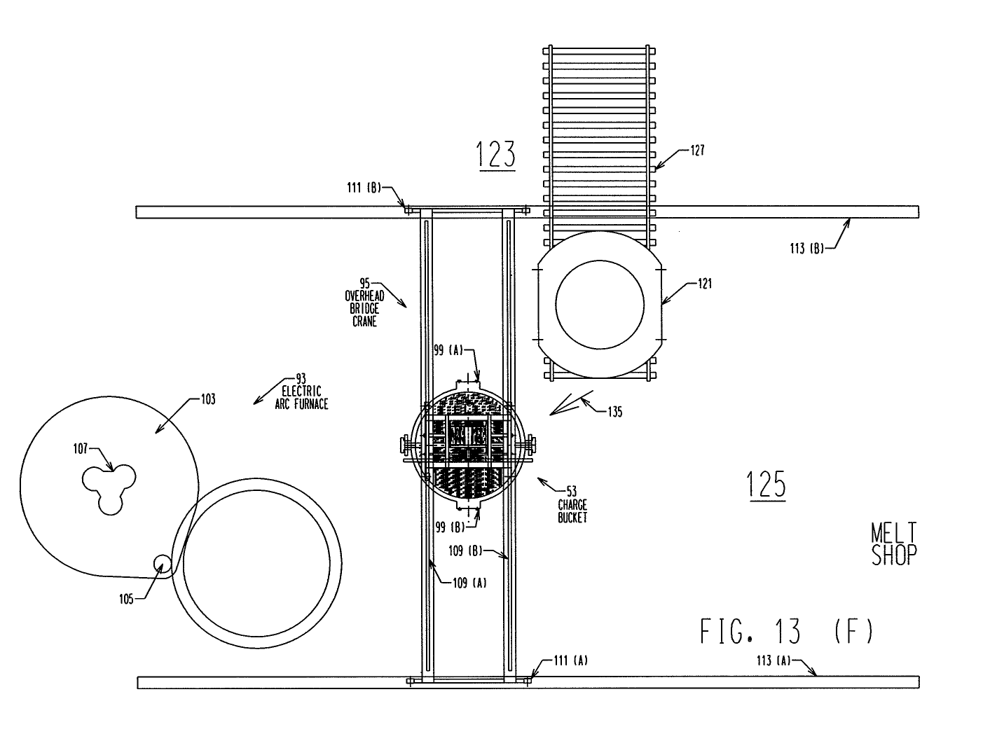

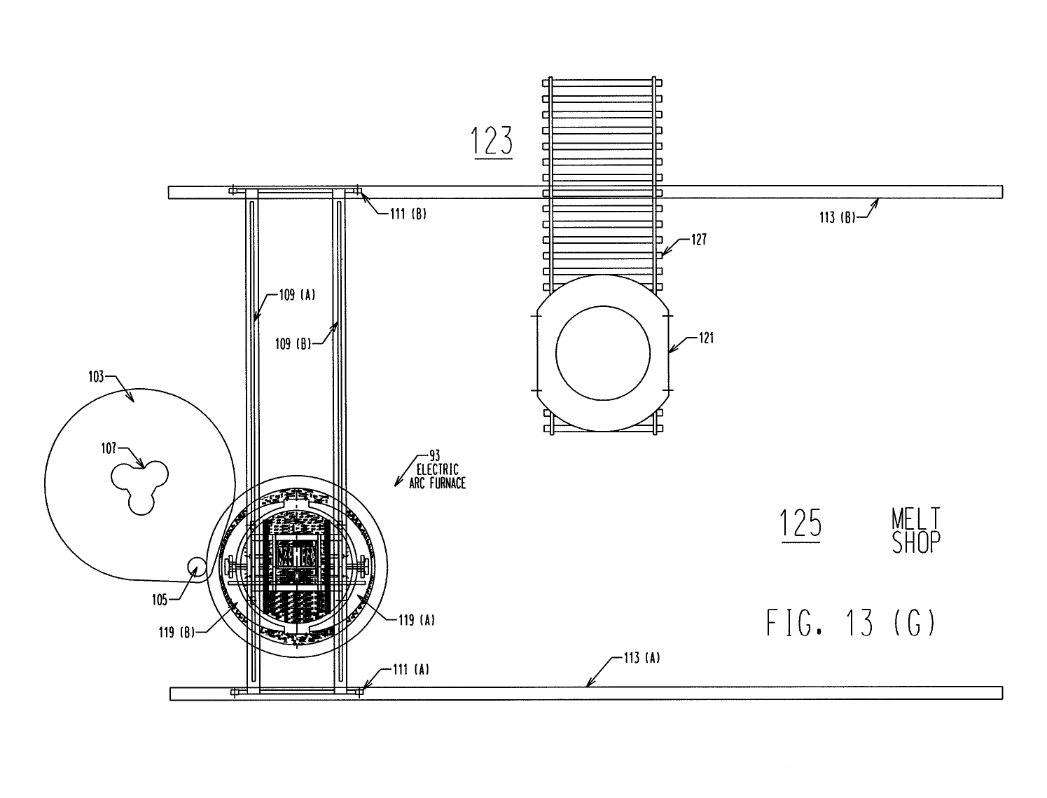

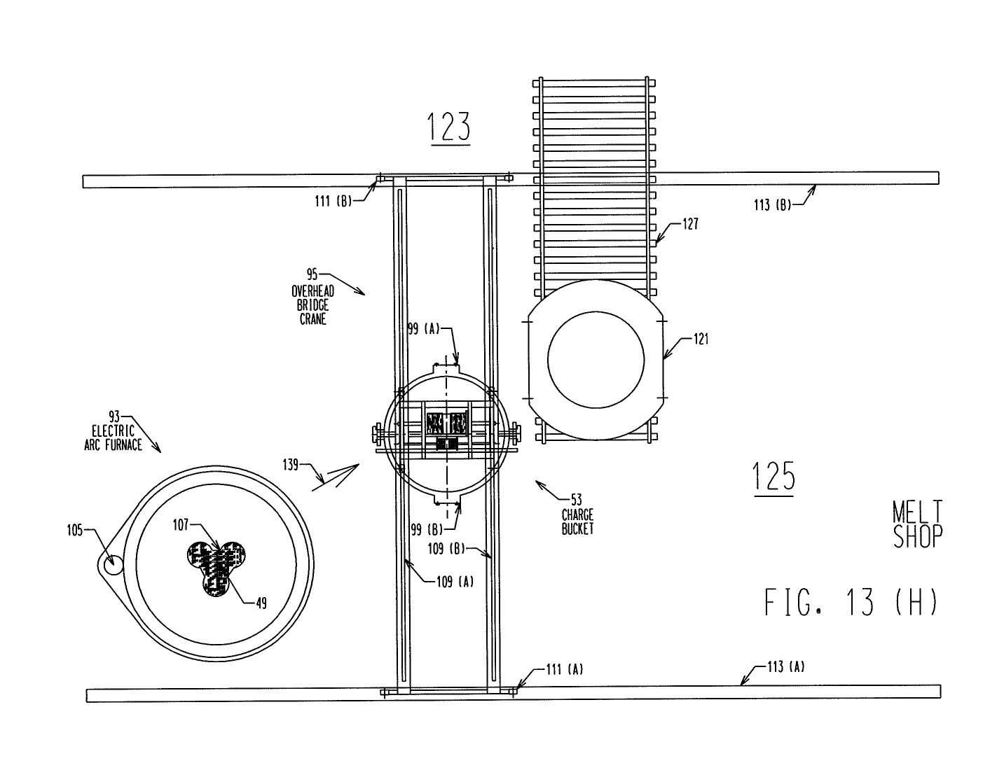

Once the rear eject body 25 of the truck 10 has the full load 49, the truck proceeds to the location of the charge bucket via the roadway 15 illustrated in FIG. 1. Before unloading, the rear of the truck 10 is backed up to the charge bucket 53 as shown in FIG. 5. As discussed in greater detail in connection with the illustrations of FIGS. 12 and 13, the charge bucket 53 may be positioned in a charging bay adjacent the melt shop of the mill or it may be within the melt shop. In either case, the relative elevations of the charge bucket 53 and the truck 10 are such that the top lip 53 (a) of the charge bucket 53 is below the rear lower edge 25 (a) of the rear eject body 25 as suggested by the relative positioning of the truck and the charge bucket in FIGS. 5-9. In FIGS. 5-9, either the surface 55 supporting the truck 10 or the surface 57 supporting the charge bucket 53 can be a ground elevation. In the case of the surface 55 supporting the truck 10 being at ground elevation, the charge bucket 53 is then positioned in a pit. Alternatively, when the charge bucket 53 is at ground elevation, the support surface 55 supporting the truck 10 is an elevated surface that the truck accesses by way of a ramp (not shown). In both cases, appropriate safety precautions are taken to ensure the truck 10 does not overrun the edge 59 between the surfaces 55 and 57. In FIGS. 5-9, a safety wedge 61 engages the back tires 47 of the truck 10 and prevents the truck from continuing to back up beyond a safe position.

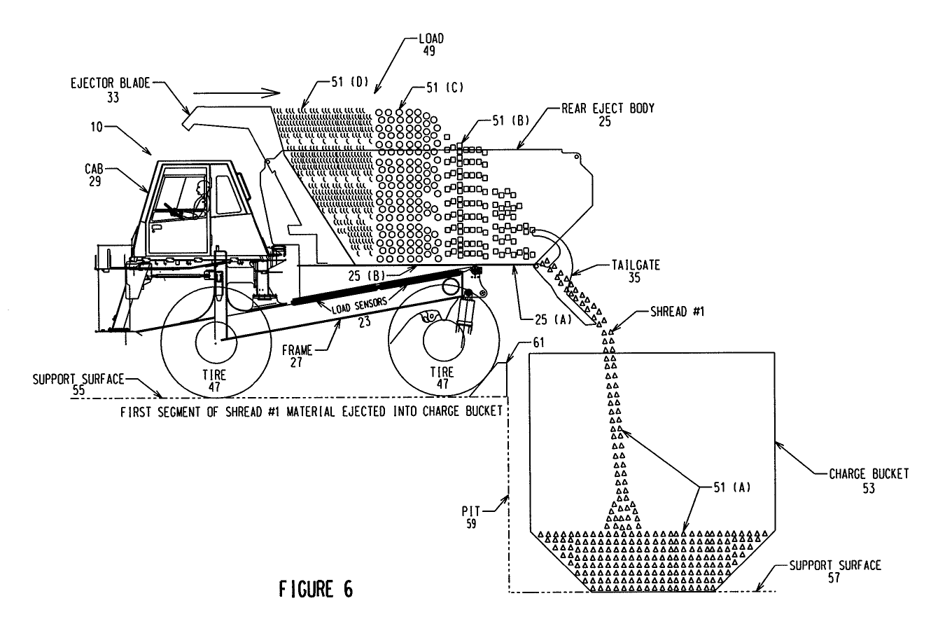

Once properly positioned, the truck 10 engages the rear ejector blade 33 to begin ejecting the steel scrap from the rear eject body 25 into the charge bucket 53. Turning to FIG. 6, the tailgate 35 of the rear eject body 25 is lowered such that steel scrap material begins to fall into the charge bucket 53 as the rear ejector blade 33 is moved backwardly toward the tailgate. With the truck 10 loaded as in the example described above, and considering that the large shredded material 51 (a) is closest to the tailgate 35, this material begins to fill the bottom of the charge bucket 53 as illustrated.

As the material falls from the body 25 to the charge bucket 53, the segment 51 (a) of the large shredded material #1 is turned 90 degrees from the vertical orientation in the body 25 to a horizontal orientation in the charge bucket 53. Because the segments of material 51 (a) through 51 (d) are pushed out of the body by the ejector blade 33, there is very little churning of the load and the material segments stay relatively in place as they were created during the loading process in the steel scrap yard 13. In this way, the ejector blade 33 serves to gradually unload the steel scrap material from the rear eject body 25 without destroying the desired charge bucket layering of the steel scrap material. In general, as any one of the segments 51 (a) through 51 (d) of the load 49 falls away from the body 25 when it is pushed over the back edge 25 (a) of a floor 25 (b) of the body, it falls into the charge bucket 53 and forms layers of different types of steel scrap material in the bucket. In effect, the vertical ordering of the segments in the load 49 along the length of the rear eject body is turned 90 degrees during the process of ejecting the load into the charge bucket 53 such that the order of segmentation or segregation of the load by steel scrap types becomes the same ordering by steel scrap types in a layering of the load in the charge bucket. Specifically, the segment of the load 49 at the rear of the rear eject body becomes the bottom layer of steel scrap type in the charge bucket 53. The segment of the load adjacent the segment at the rear become the next layer and so on until all of the segments are ejected and form layers by steel scrap type in the charge bucket.

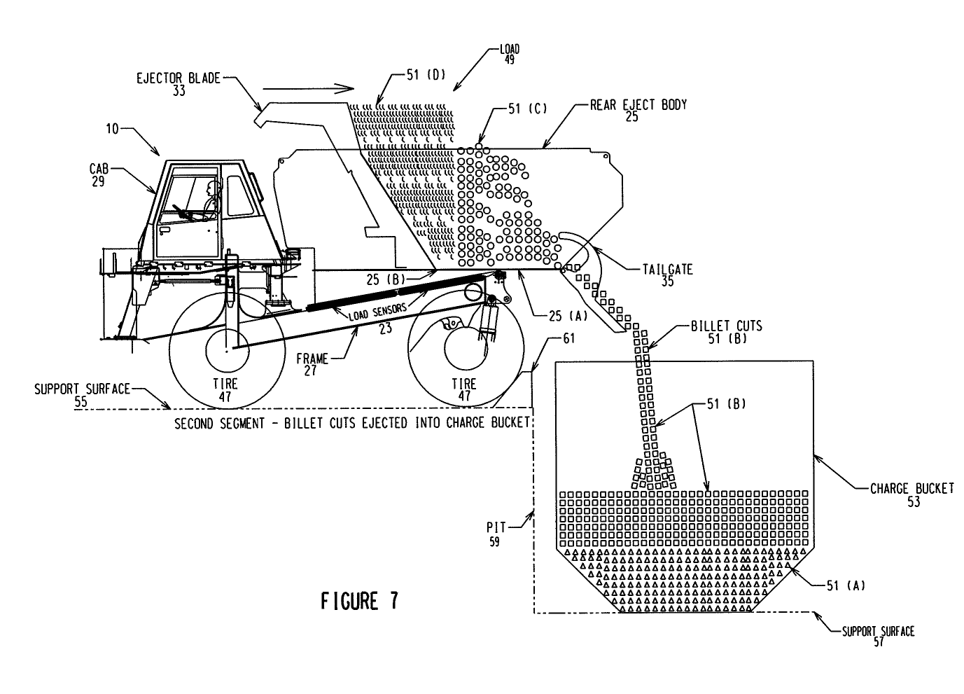

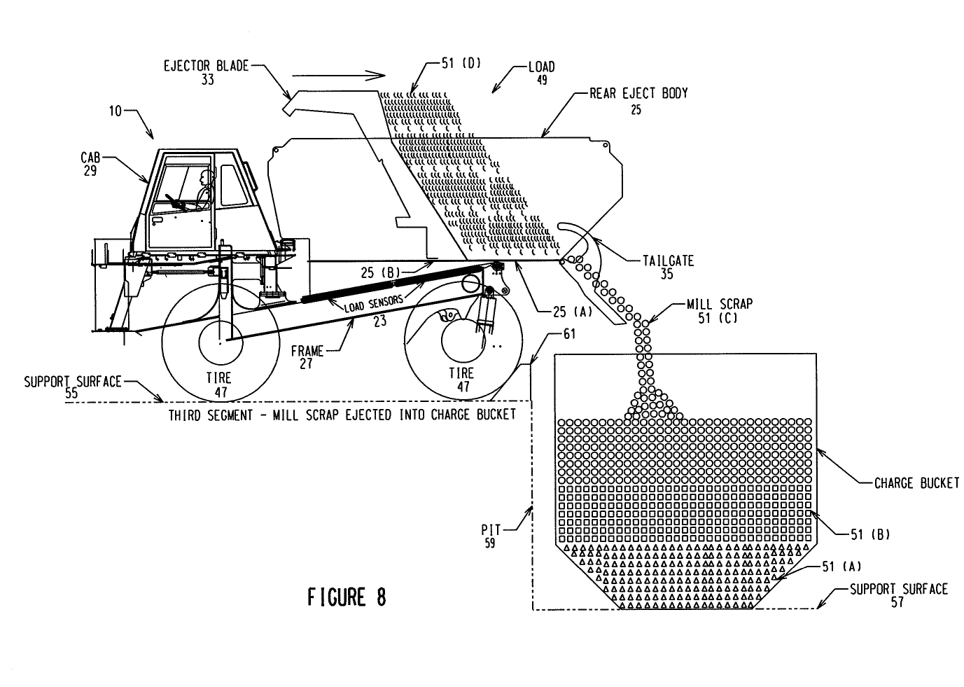

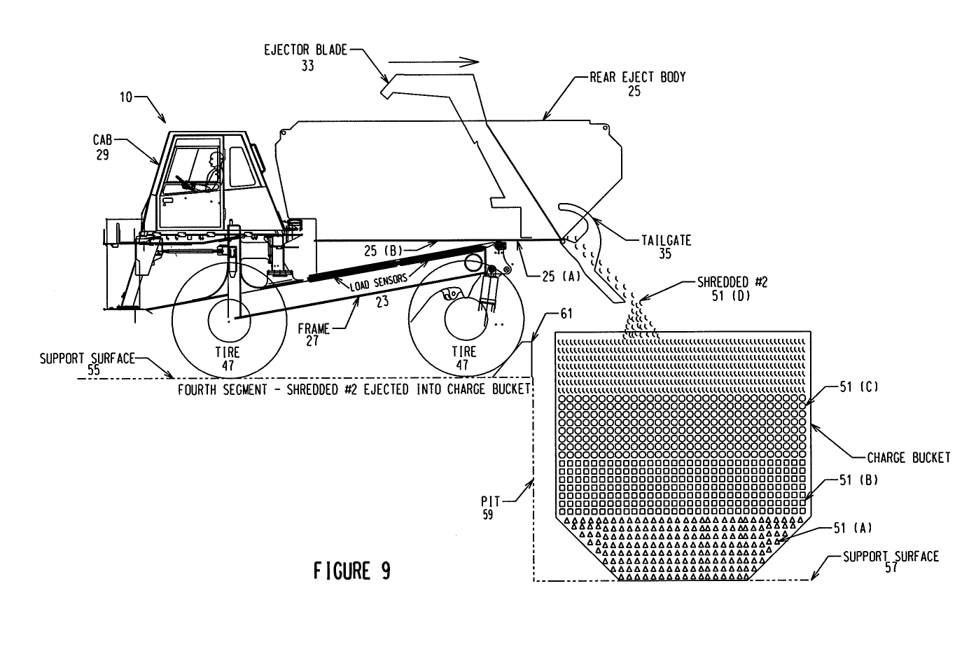

Referring to FIG. 7, once most of the entire segment 51 (a) of shredded scrap material #1 falls into the charge bucket 53 and forms a layer, the adjacent segment 51 (b) of billet cuts in the rear eject body 25 begins to be ejected by the continued movement of the ejector blade 33. Similarly, as shown in FIGS. 7 and 8, as the final amounts of the segment 51 (b) of billet cut scraps are ejected from the rear eject body, the next segment 51 (c) of mill scraps begins to fall into the charge bucket 53 and creates a layer of material of one type, segregated from layers of other steel scrap types. Finally, as shown in FIG. 9, the segment 51 (d) of shredded scrap #2 is generally the last material to fall into the charge bucket 53, and thus, the layer of shredded scrap #2 is generally disposed across the top of the charge bucket as shown in FIG. 9. As previously mentioned, many different charge bucket layering compositions may be desirable, depending on the characteristics of the metal, the electric arc furnace and of the charge bucket 53. In this regard, the illustrated layering is only exemplary and not intended to be limiting.

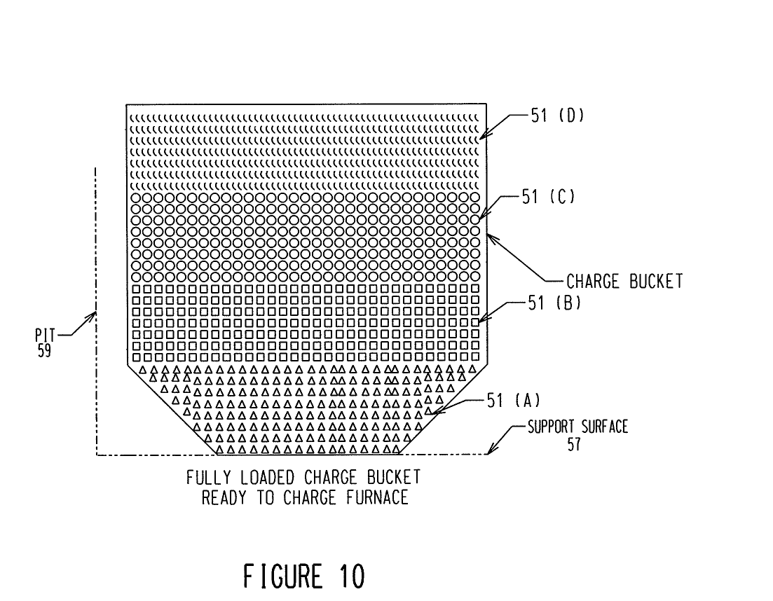

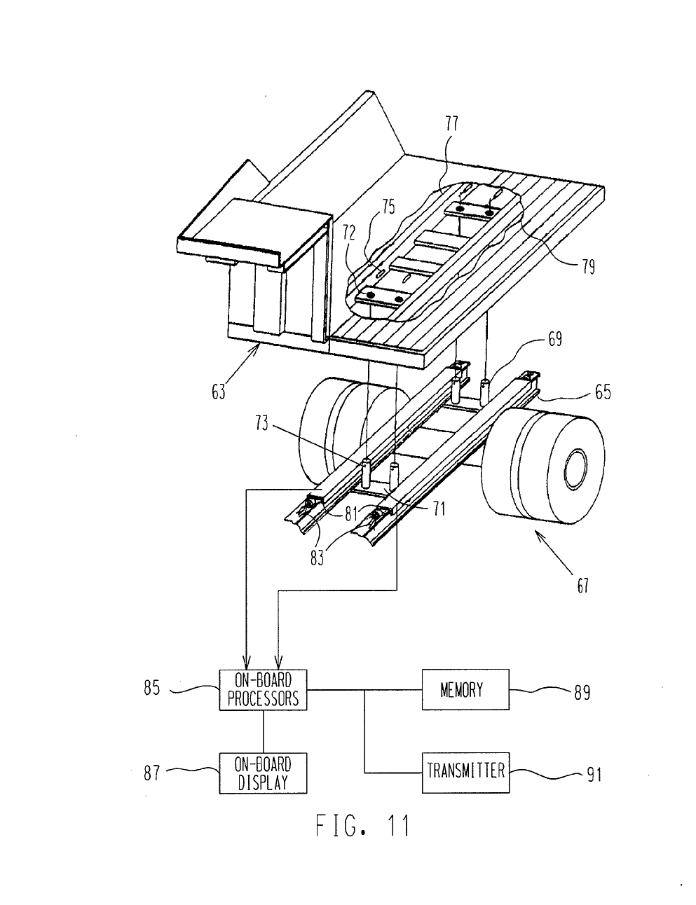

As best shown in FIG. 10, once all of the segmented load 49 has been pushed out of the body 25 by the movement of the ejector blade 33, the charge bucket 53 contains the load 49 in a generally undisturbed layered state whose order of material types from bottom to top is the same as the order of the types of material in the segmented load from the back of the body 25 to the front. The rear eject action of the truck 10 allows the deliberate segmentation of the load 49 by steel scrap type created during the loading of the body 25 to be substantially maintained and reproduced in the layering of the load in the charge bucket 53. Because the segments 51 (a) through 51 (d) of the load 49 generally slide off the rear end of the body 25 by the movement of the ejector blade 33, there is virtually no churning between the segments, which allows each segment to drop from the body into the charge bucket substantially unmixed with any of the other types of steel scrap in the other segments. Thus there is only minimal churning action occurring in the charge bucket 53 when a segment of the load 49 hits the charge bucket or the layer of material previously loaded into the charge bucket. This churning action is useful and not detrimental to the aim of maintaining layers of different types of scrap material because the churning in the charge bucket tends to distribute the segment to form a layer without disturbing in any substantial way a layer created by a segment previously ejected as suggested by the illustrations in FIGS. 5-9. As each of the segments 51 (a) through 51 (d) hits the bottom of the charge bucket 53, it spreads outwardly, tending to orient itself as a layer across the bucket, thereby re-orienting itself from a segment in the vertically ordered segmentation of the load 49 in the rear eject body 25 to a horizontally disposed ordering in the layering of the steel scrap types in the charge bucket 53. With the process of loading the segmented load 49 into the charge bucket 53 maintaining the order and separation state created when the crane 17 loaded the steel scrap material into the body 25, the charge bucket now contains the load 49 in its intended layered state, which when loaded into the electric arc furnace reduces the amount of energy otherwise needed to process the scrap material.

Referring to FIG. 11, a fixed body 63 suitable for use with the ejector blade 33 to function as the rear eject body 25 is fitted to a frame 65 of a truck 67 in order to provide an on-board weighing system. The particular means for coupling the frame 65 to the body 63 in FIG. 11 allows the full weight of the body to rest upon the load sensors 81. In one embodiment of the invention, the load sensors 81 are the same as the load sensors 23 in FIGS. 2-9.

In the illustrated embodiment, pins 69 are supported by cross members 71 of the frame 65 and cooperating bores 72 in cross members, prevent fore-and-aft or side-to-side movement of the body relative to the frame while, at the same time, allowing free vertical movement of the body 63. In order to prevent the body 63 from accidentally freeing itself from the frame 65 by bouncing high off the frame, a pin or similar retainer means 75 is secured at the top of the pins 73 in order to limit the vertical movement of the body. The entire weight of the body 63 and the load of layered scrap material such as the load 49 in FIGS. 5-9 are transferred to the vehicle frame 65 by way of the interface between the beams of the frame and the beams 77 and 79 of the body.

Details of the load sensors 81 are set forth in U.S. Pat. No. 5,742,914, which is herein incorporated by reference. Electrical signals are provided at the outputs of pressure transducers 83, which are fed to a processor 85 on-board the truck of FIG. 11. The processor 85 and its supporting hardware and software are described in detail in the above-identified '914 U.S. Patent. In FIG. 11, the processor 85 is shown with a display 87, a memory 89 and a transmitter 91. In general, the processor 85 may simply provide total weight information to the display 87, which is mounted in the cab 29 of the truck 10 or it could be mounted externally so the operator of the crane 17 can see the total weight as the body 53 is loaded. The memory 89 can hold historical data or data that has been processed in a manner in keeping with the description of the weight data processing in the '914 patent. The transmitter 91 allows data to be delivered in real time to a remote location for storage and/or processing. Also, the transmitter 91 can communicate the weight data to a display (not shown) within the cab 31 of the crane 17, thereby allowing the crane operator to easily monitor the weight of the load as the crane adds scrap material during the loading process.

Turning now to FIGS. 12 and 13, an overhead view of a melt shop of the steel mill serviced by the steel scrap yard 13 in FIG. 1 shows the charge bucket 53, an electric arc furnace 93 and an overhead bridge crane 95 for moving the charge bucket from a location where it is loaded by the truck 10 as illustrated in FIGS. 5-9 to a position overhead of the electric arc furnace for delivering the load 49 carried by the charge bucket to the electric arc furnace. Each of the sequence of illustrations in FIGS. 12 and 13 follows the load 49 in FIGS. 5-9 from the time it begins loading into the charge bucket until the bucket releases it into the electric arc furnace 93.

As perhaps best shown in FIGS. 12 (a) and 13 (a), the charge bucket 53 typically is hinged such that the bottom of the charge bucket comprises two clam shell halves that close to form a bottom of the charge bucket until the overhead bridge crane 95 works the hinges to open the clam shell and release the load 49 carried by the charge bucket into the electric arc furnace. The junction between the two clam shell halves at the bottom of the charge bucket 53 is illustrated in FIGS. 12 (a) and 13 (a) as a line 97. The hinges of the clam shell halves are 99 (a) and 99 (b) in FIGS. 12 (a) and 13 (a). The overhead bridge crane 95 picks up the charge bucket 53 from its position in FIGS. 5-9 by lifting the charge bucket at the trunions 101 (a) and 101 (b) located on opposing sides of the charge bucket. As best seen in FIGS. 12 (a) and 13 (a), the overhead bridge crane 95 includes large and small spooled cables 96 and 98, respectively, the large spool 96 is for lifting the charge bucket 53, the small spool 98 controls the opening of the clam shell halves to free the load to fall into the electric arc furnace.

FIGS. 12 and 13 (a) through (d) and (g) show the electric arc furnace with a closed lid 103 that pivots in the plane of the page about a pivot 105. The top 103 has a three-lobed opening 107 that receives electrodes from above for melting the steel scrap metal after it is loaded into the electric arc furnace 93 by the charge bucket 53.

Generally, the melt shop is defined by the area accessible by the overhead bridge crane 95. In FIGS. 12 and 13, the overhead bridge crane 95 is capable of moving along x-y axes as indicated. Motors drive (not shown) the overhead bridge crane 95 trolley along parallel support rails 109 (a) and 109 (b) in the x-axis direction. The rails 109 (a) and 109 (b) have cross members 111 (a) and 111 (b) in order to mount the rails to parallel rails 113 (a) and 113 (b) oriented along the y axis such that the rails are perpendicular to rails 109 (a) and 109 (b). Motors (not shown) drive the overhead bridge crane, bridge comprising the overhead bridge crane 95 and the rails 109 (a) and 109 (b) along the rails 113 (a) and 113 (b) in the y-axis direction. An operator of the overhead bridge crane 95 controls movement of the overhead bridge crane by way of a motor control system (not shown) in a conventional manner.

Referring now to the sequence of time stopped snapshots in FIGS. 12 (a) through 12 (h), the loading of the charge bucket 53 begins with the charge bucket positioned at the edge of the melt shop as shown in FIG. 12 (a), which corresponds to the FIG. 5. In this regard, the truck 10 is either supported on an elevated platform or the charge bucket is supported in a pit. FIGS. 12 (b) and 12 (c) show the charge bucket being loaded in a manner consistent with that shown in FIGS. 6-9. Once the load 49 has been completely transferred to the charge bucket 53, the truck 10 leaves the charging bay area and returns to the steel scrap yard 13 of FIG. 1 for another load as generally suggested by the arrow 115 in FIG. 12 (c). While the truck 10 returns to the steel scrap yard 13, the overhead bridge crane 95 moves toward the charge bucket 53 as indicated by the arrow 117 in order to lift up the charge bucket using the large cables of the spool 96.

In FIG. 12 (d), the overhead bridge crane 95 is in place above the charge bucket 53 loaded with the layered load 49. The overhead bridge crane 95 latches on to the charge bucket in a conventional manner. Also in a known manner, an auxiliary overhead bridge crane hook controlled by the smaller spool 98 latches on to a charge bucket clam shell door spreader bar 100, which is best seen in FIGS. 12 (a) and 13 (a). The overhead bridge crane 95 lifts the charge bucket 53 and begins moving the charge bucket to a position directly over the electric arc furnace 93. As the overhead bridge crane 95 moves the loaded charge bucket 53 toward the electric arc furnace 93, the top 103 of the electric arc furnace is opened as illustrated in FIG. 12 (e).

In FIG. 12 (f), the overhead bridge crane 95 has positioned the charge bucket 53 directly overhead of the electric arc furnace 93. The mated clam shell halves of the bucket 53 are opened by the auxiliary overhead bridge crane hook controlled by spool 98 acting on the spreader bar 100. The opened clam shell halves can be seen as 119 (a) and 119 (b) in FIG. 12 (f). The opening of the clam shell halves 119 (a) and 119 (b) frees the load 49 to drop down by the pull of gravity into the electric arc furnace 93. Because the load 49 drops straight down (into the drawing page), there is little or no mixing of the layers in the charge bucket load 49. After releasing the load 49, the clam shell halves 119 (a) and 119 (b) are closed in FIG. 12 (g) and the overhead bridge crane 95 returns the charge bucket 53 to the loading area to meet the truck 10 returning from the steel scrap yard 13 with another load 49.

FIGS. 13 (a) through 13 (h) illustrate the same time snapshots of a sequence of loading the charge bucket 53 with the load 49 from the truck 10 as illustrated in FIGS. 12 (a) through 12 (g), except in FIGS. 13 (a) through 13 (h) the empty charge bucket 53 is positioned outside the melt shop—see FIG. 13 (a). Because the overhead bridge crane 95 cannot access the charge bucket 53 outside of the melt shop, the charge bucket is mounted on a transport vehicle 121 that moves between a charging bay area generally noted as 123 in FIGS. 13 (a) through (g) and a location within the melt shop generally noted as 125 in FIGS. 13 (a) through 13 (h). The transport vehicle 121 is of conventional design and is not described herein in further detail. In FIGS. 13 (a) through 13 (h), the transport vehicle 121 moves along rails 127. Alternatively, the transport vehicle 121 could be supported on ground wheels or tracks to move the charge bucket 53.

Once in place in the area of the charging bay, loading of the charge bucket 53 proceeds in much the same manner as described in connection with FIGS. 12 (a) through 12 (g). The arrow 129 in FIG. 13 (a) shows the truck 10 backing into the position illustrated in FIG. 5. In FIG. 13 (b), the ejector blade 33 begins sliding the load 49 backward as indicated by arrow 131 and the segments of the load fall into the charge bucket 53 as previously discussed. With the load 49 transferred to the charge bucket 53, the transport vehicle 121 begins moving the charge bucket along the direction shown by the arrow 133 in FIG. 13 (c) from the charging bay area into the melt shop so that the overhead bridge crane 95 can access the bucket. When the charge bucket 53 is fully inside the melt shop the movement of the vehicle 121 (arrow 135 in FIG. 13 (d)) stops. The overhead bridge crane 95 is then able to access the charge bucket 53 and FIG. 13 (d) shows the charge bucket in a position ready for lifting by the overhead bridge crane and the overhead bridge crane is moving to the area of the charge bucket as indicated by arrow 137.

In FIG. 13 (e), the overhead bridge crane 95 is positioned over the loaded charge bucket 53, the cable controlled by the large spool 96 of the overhead bridge attaches to the trunions 101 (a) and 101 (b) in a conventional manner and lifts the charge bucket to a vertical height for transporting to the electric arc furnace 93. Arrow 135 in FIG. 13 (f) shows the overhead bridge crane 95 is moving the charge bucket 53 toward the electric arc furnace 93 and the electric arc furnace has opened its top 103 in anticipation of the arrival of the charge bucket. Like FIG. 12 (f), FIG. 13 (g) illustrates the two clam shell halves 119 (a) and 119 (b) of the charge bucket 53 opening under the control of the cable of the small spool 98 attached to the spreader bar 100 and releasing the load 49 into the electric arc furnace 93. In FIG. 13 (h), the electric arc furnace lid or top 103 is closed and ready to receive the electrodes to melt the load 49 now in the electric arc furnace. The overhead bridge crane 95 is moving the charge bucket 53 back to the transport vehicle 121 as suggest by arrow 139.

Referring now more particularly to the rear eject hauler or truck 10 of FIGS. 1-13, there is shown in FIGS. 14-27 an illustrative off-highway truck 10 incorporating the rear eject body 25 for ejecting the segmented load 49 into the charge bucket 53 as described above. The details of the truck and the rear eject body 25 described hereinafter in connection with FIGS. 14-27 are based on the truck and rear eject body described in co-pending U.S. patent application Ser. No. 11/945,117 and U.S. Pat. No. 7,326,023, both of which have been incorporated by reference into this application for everything they describe and teach without exception.

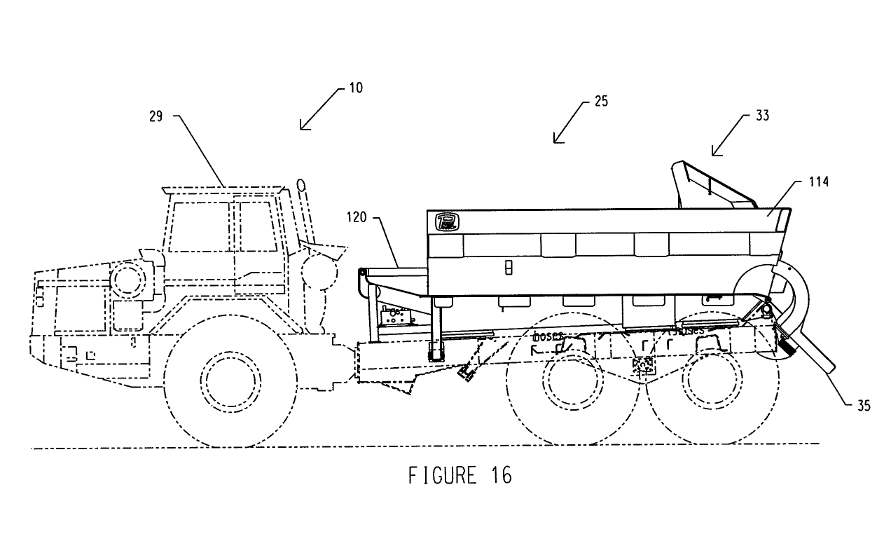

The illustrated rear eject body 25 consists of the floor 25 (b), two sidewalls 114, the tailgate 35 and the ejector blade 33. The ejector blade 33 when actuated pushes a load such as the load 49 in the rear eject body 25 from the front of the rear eject body out the rear of the rear eject body. In particular, the ejector blade 33 is moved from a body loaded or fully retracted position at the front of the rear eject body 25 (see, e.g., FIG. 14) to a body empty or fully extended position at the rear of the rear eject body 25 (see e.g., FIG. 16) by, in this case, a multi-stage, double-acting hydraulic cylinder 120. As used herein, the terms “front” and “forward” and “rear” and “rearward” are used with respect to the truck cab 29 being at the front end of the truck 10 and the tailgate 16 being at the rear end of the truck 10 (see FIGS. 14 and 16).

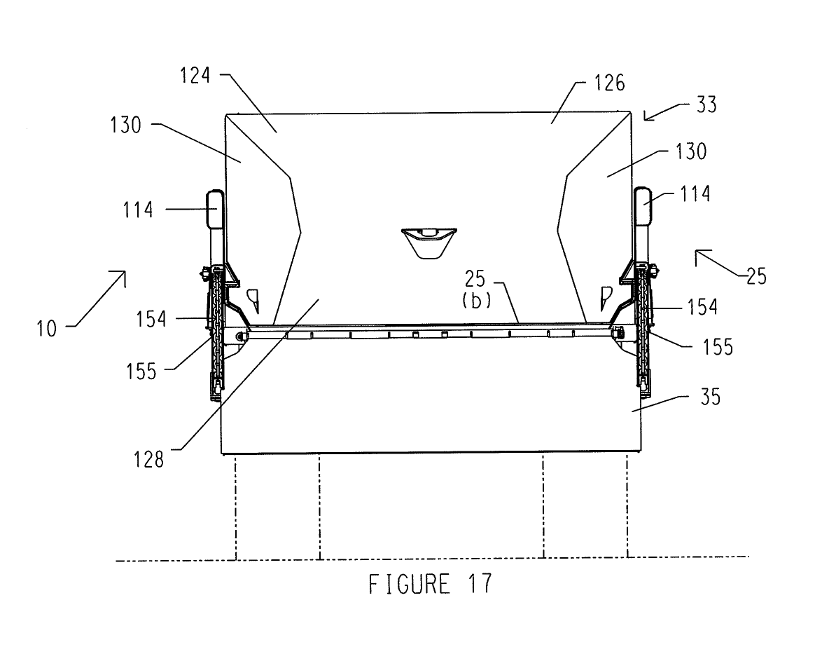

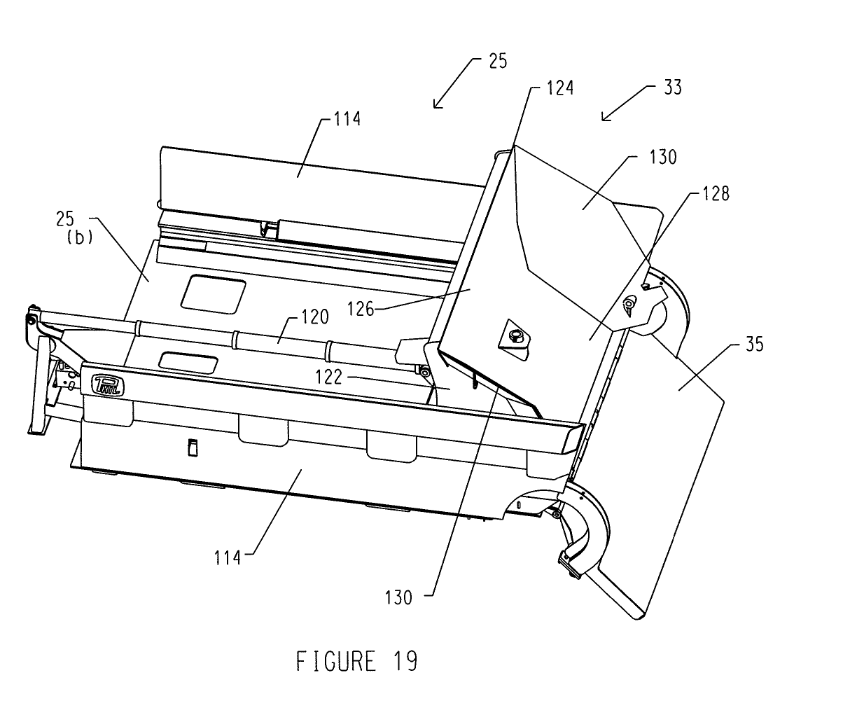

In the illustrated embodiment, the ejector blade 33 generally includes a frame 122 (see FIGS. 19-21) that supports an ejector plate 124. As shown in FIGS. 17-19, the ejector plate 124 is oriented so as to face towards the rear end of the rear eject body 25 and extends between the sidewalls 114 of the rear eject body 25 and upwards from the floor 25 (b) of the rear eject body 25 to a distance above the upper edges of the sidewalls 114. The illustrated ejector plate 124 includes an upper face 126, a lower face 128 and a pair of opposing side faces 130. To pull material away from the sidewalls 114 and direct it towards the center of the rear eject body 25, each of the side faces 130 of the ejector plate 124 angles inward towards the center of the body 25 as it extends forward toward the front end of the rear eject body. The lower face 128 of the ejector plate 124 angles upward away from the body floor 25 (b) as it extends forward toward the front end of the rear eject body 25 to help lift material up and somewhat off the body floor. The upper face 126 of the ejector blade 24, in turn, angles downward towards the body floor 25 (b) as it extends forward toward the front end of the rear eject body 25. This configuration helps prevent material from tumbling over the top of the ejector plate 24 when it is pushing material rearward.

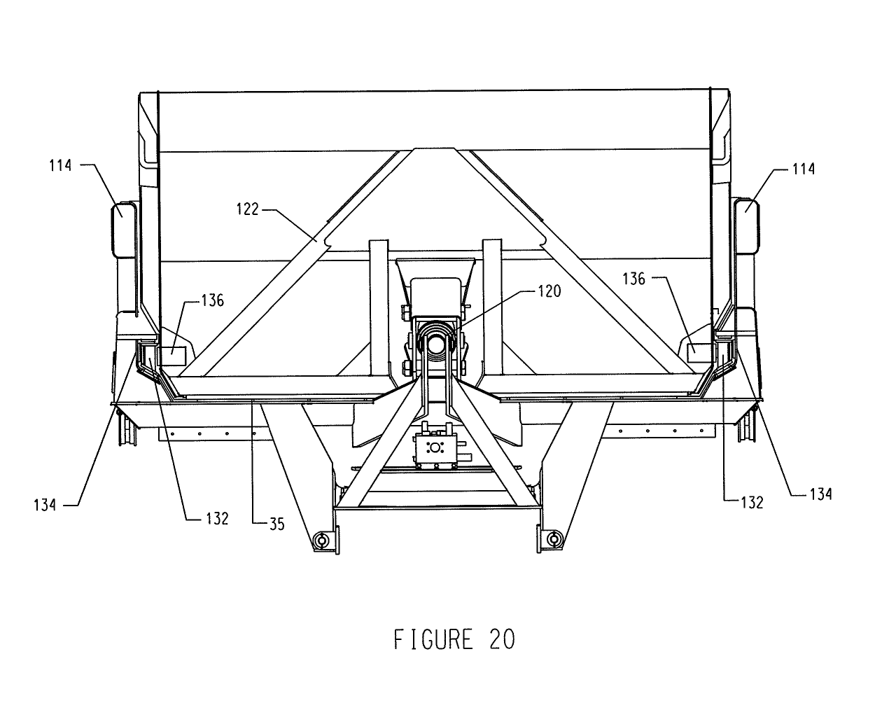

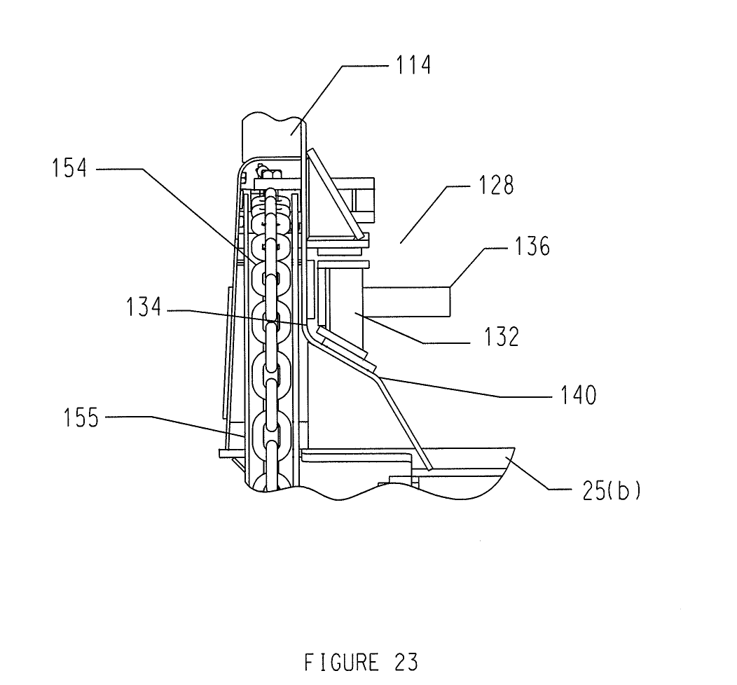

To guide the ejector blade 33 as it moves between the body loaded or fully retracted position at the front of the rear eject body 25 and the body empty or fully extended position at the rear of the rear eject body 25, the ejector blade 33 includes a guide assembly 128 (see FIG. 23). The guide assembly 128 for the ejector blade 33 include sleds 132 (see, e.g., FIGS. 20 and 23) that are received and slide in corresponding guide tracks 134 (see, e.g., FIGS. 20-23) arranged along the sidewalls 114 of the rear eject body 25. Unlike conventional rollers and cam followers, the sleds 132 and guide tracks 134 do not have any lubrication points, thereby substantially reducing the required maintenance for the ejector blade 33.

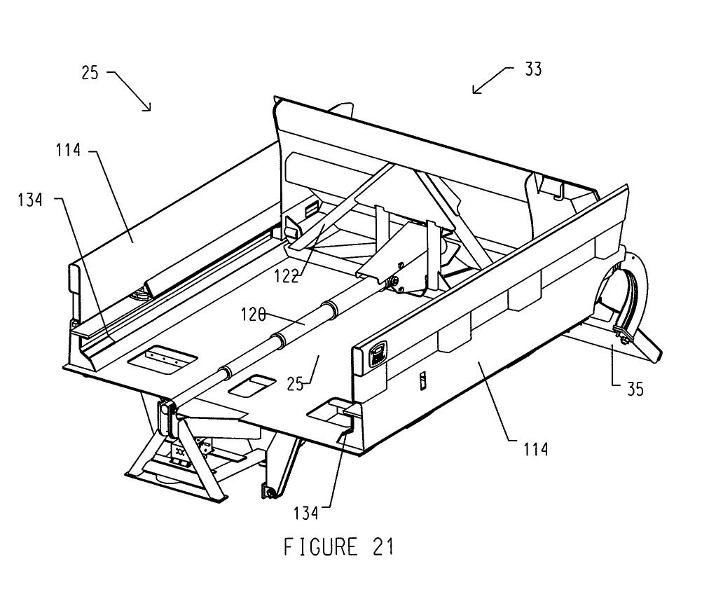

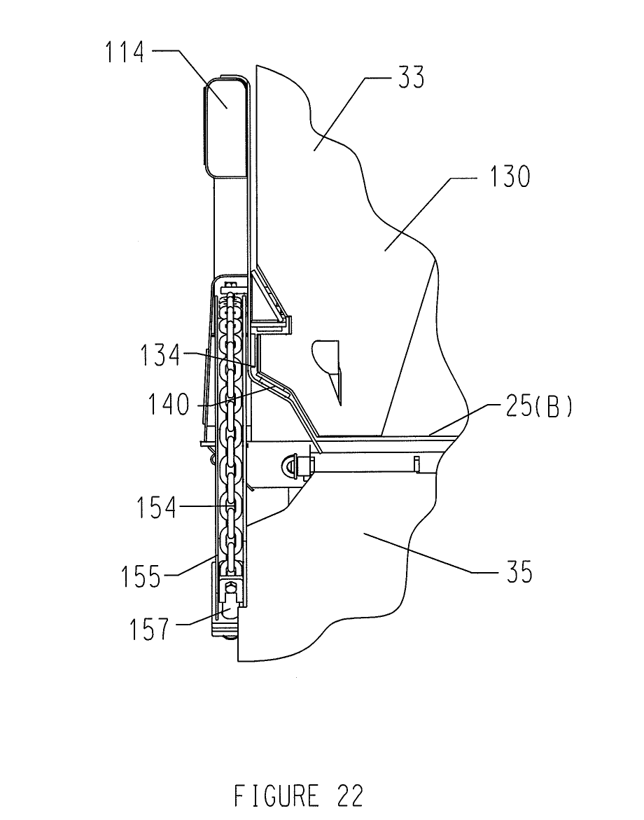

One guide track 134 is arranged along the inner side of each of the two sidewalls 114 of the rear eject body 25 (one of the tracks can be seen in FIGS. 22 and 23 and both can be seen in FIG. 20). In the illustrated embodiment, the ejector blade 33 has two sleds 132 on each side of the ejector blade frame 122. These sleds 132 are positioned near the four bottom corners of the ejector blade 33. Each sled 132 is supported on the end of a respective rod 136 (FIG. 23) that is received in a corresponding tube on the ejector blade 33. The use of the rods 136 allows the position of the sleds 132 to be adjusted relative to the ejector blade 33 thereby ensuring a good fit.

To facilitate sliding of the sleds 132 in the guide tracks 134, the sleds 132 can be made of or plated with a hardened steel material. Additionally, the guide tracks 134 in which the sleds 132 ride can also be lined or made out of a very hard steel material such as the same material used for the sleds 132. In particular, the three sides of the guide track 134 (i.e., outside, upper and lower walls of the track—see FIG. 23) can be either lined or made of a very hard steel material. Two examples of steel materials that are suitable for use in constructing the sleds 132 and guide tracks 134 are Hadfield manganese steel, which is 11-14% manganese steel, and the fused alloy steel plate sold under the tradename Arcoplate by Alloy Steel International, Inc. of 42 Mercantile Way P.O. Box 3087 Malaga DC 6945, Western Australia. Arcoplate wear plate consists of a chromium carbide rich (+/−60%) steel alloy overlay on a mild steel backing. Additional information regarding the Arcoplate material can be found at www.arcoplate.com.au. One example of a suitable Hadfield manganese steel is the wear-resistant high manganese steel sold under the tradename Manganal by Stulz Sickles Steel Company of Elizabeth, N.J. Manganal is a high manganese austentitic, work hardening steel that typically is 126-14% manganese and 1.00-1.126% carbon. Additional information regarding the Manganal material can be found at www.stulzsicklessteel.com. The Hatfield manganese and Arcoplate materials are very hard such that each can operate against itself without galling.

To facilitate cleaning of the guide tracks 134, the guide tracks can be configured so as to have a bottom wall 140 angling downward and inward toward the center of the rear eject body 25 as it extends away from the body sidewall 114 as shown, for example, in FIGS. 22 and 23. When the sleds 132 slide back and forth in the guide tracks 134, the debris that is dislodged by the sleds 132 falls onto the bottom wall 140 of the guide track 134. Because it is set at an angle, the debris that falls on to the bottom wall 140 of the track 134 slides or is otherwise directed out of the guide track 134 and towards the center of the rear eject body 25. In the embodiment illustrated in FIGS. 22 and 23, the guide tracks 134 are also elevated a distance above the body floor 25 (b). The elevation of the guide tracks 134 creates space for any debris that is expelled from the guide tracks 134.

To reduce the friction associated with ejecting material from the rear eject body 25, the floor 25 (b) of the rear eject body can be lined with a material having a low coefficient of friction as compared to conventional steel plate. Using a material with a relatively low coefficient of friction reduces the amount of force necessary to eject material from the rear eject body 25. As a result, a relatively smaller hydraulic cylinder 120 can be used to move the ejector blade 33 thereby reducing the cost of the rear eject body 25. The use of a low coefficient of friction material also results in a relatively faster movement of the ejector blade 33 between the retracted and extended positions. Two examples of suitable materials for lining the body floor 25 (b) are Hadfield manganese steel and the wear plate sold under the Arcoplate tradename mentioned above. As noted above, both Hadfield manganese steel and Arcoplate wear plate are extremely hard, and when polished, have an extremely low coefficient of friction. Advantageously, these materials are also very resistant to abrasion and wear caused by material sliding across the body floor 25 (b).

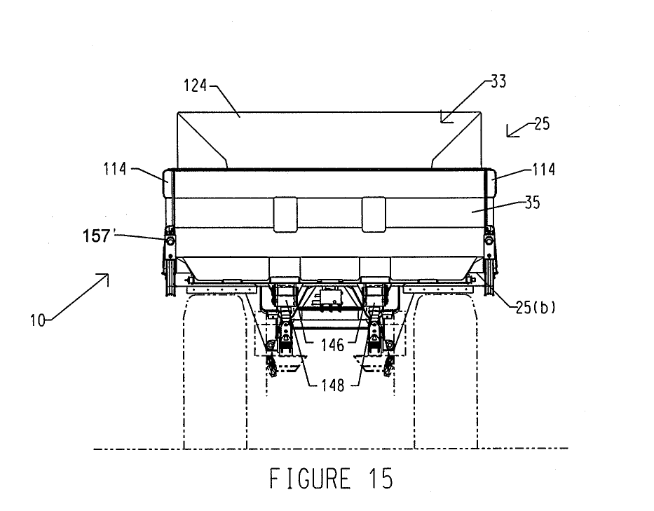

To allow the illustrated rear eject body 25 to be easily mounted to existing trucks that are configured to receive a pivotable dump body, the rear eject body 25 can be configured to be mountable to the standard truck chassis dump body pivot mounts. In particular, as best shown in FIGS. 14, 15 and 18, a pair of mounting brackets 146 is provided on the underside of the body floor 25 (b) adjacent the rear end thereof. When installing the rear eject body 25, these mounting brackets 146 can be connected to the dump body pivot mounts 148 that are typically provided on a truck chassis configured to receive a pivotable dump body such as in the illustrated embodiment (see, e.g., FIGS. 14 and 15).

To control movement of the tailgate 35 between the open and closed positions so that the load can be ejected out of the body 25, the illustrated rear eject body includes a tailgate actuation system. Advantageously, unlike many rear eject bodies that use separate hydraulic cylinders at the rear of the body to move the tailgate, the tailgate actuation system utilizes the action of the single hydraulic cylinder 120 to operate both the ejector blade 33 and tailgate 35. This reduces the required maintenance as well as the cost of the rear eject body 25 by eliminating any additional hydraulic cylinders, hydraulic lines and hydraulic controls conventionally associated with operating the tailgate. The tailgate actuation system links movement of the tailgate 35 to movement of the ejector blade 33 helping to ensure that the tailgate opens quickly and reliably during dumping. In particular, the actuation of the ejector blade 33 from the fully retracted position to a partially extended position controls the opening and closing of the tailgate 35 at the rear of the rear eject body 25.

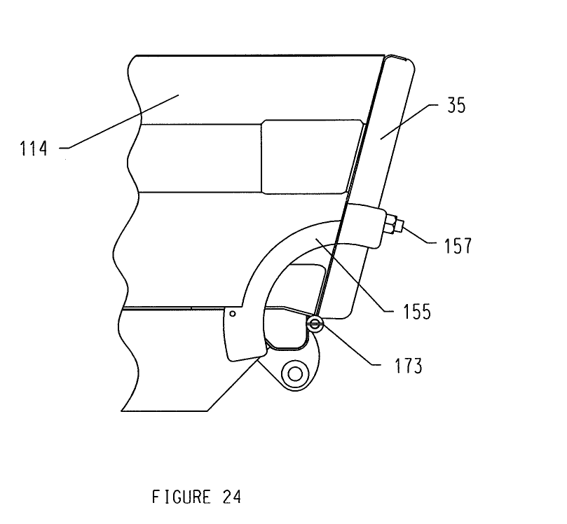

The tailgate actuation system includes a chain 154 as seen in FIGS. 17, 22 and 23. The chain 154 wraps around a chain drum and connects to the tailgate 35 at 157 in FIGS. 22 and 24. With the ejector blade 33 fully retracted, the tailgate 35 is held closed by the engagement of the tailgate release lever (not shown) with a stop surface on the ejector blade 33. As the ejector blade 33 starts to move rearward in order to eject a load, the tailgate 35 is freed to swing into its fully open position in FIG. 19.

Advantageously, when a load is being ejected, the tailgate 35 is released and is fully open after very minimal rearward movement of the ejector blade 33 so that the load can be ejected from the rear eject body 25

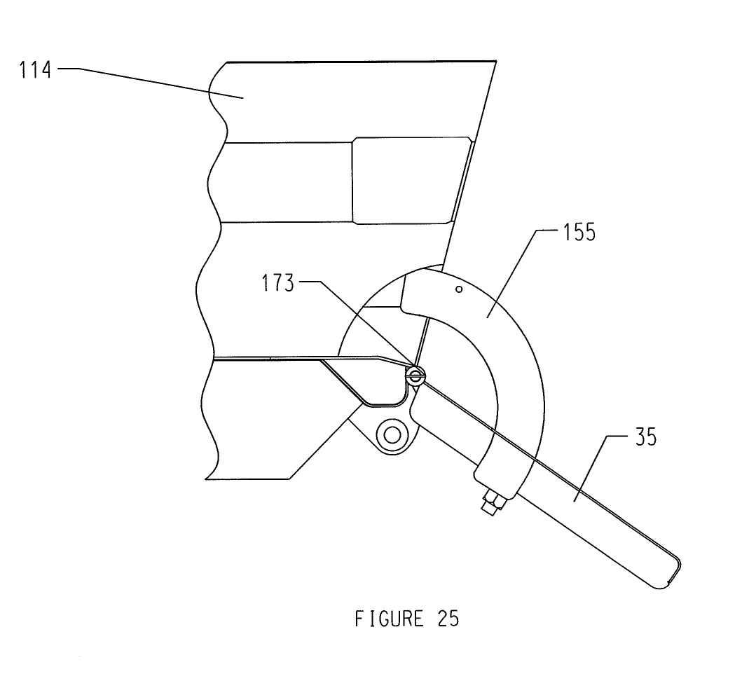

The chain drum 155 in FIGS. 17, 22, 23, 24 and 25 is arranged and configured such that it has a constant radius of actuation but it may have a center of rotation that is different than the tailgate pivot point 173 as shown in FIGS. 24 and 25. With this arrangement, the smallest moment arm for the chain 154 is provided when the tailgate 35 is in the fully open position and the greatest moment arm for the chain 154 is provided when the tailgate is nearly fully closed. Accordingly, less force is required to be applied to the chain 154 in order to hold the tailgate 35 in the closed position.

Details of the tailgate actuation system are set forth in U.S. Pat. No. 7,326,023, which has been incorporated by reference herein.

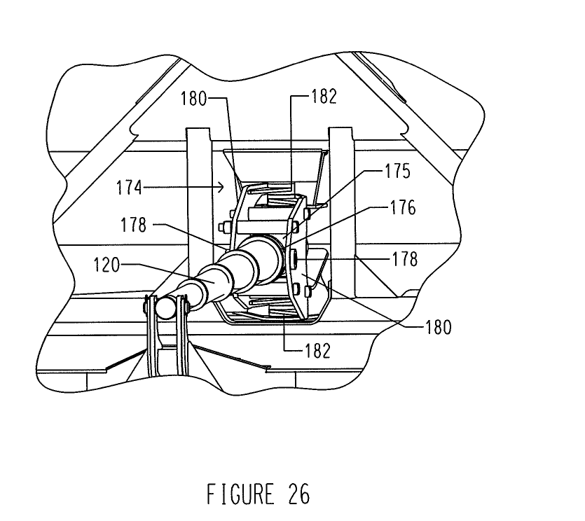

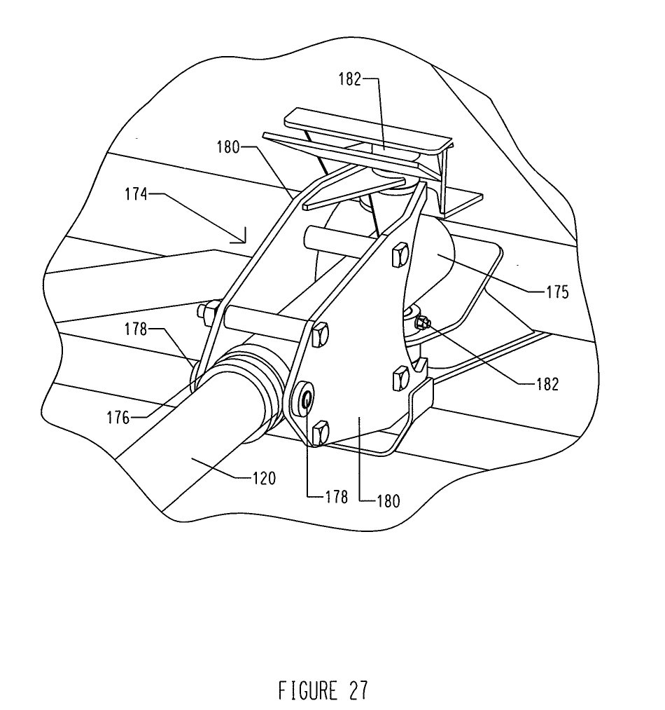

To prevent any twisting movement of the ejector blade 33 from inducing forces into the hydraulic cylinder 120, a hydraulic cylinder mounting arrangement can be provided which permits movement of the ejector blade 33 relative to the hydraulic cylinder 120. In the illustrated embodiment, the hydraulic cylinder mounting arrangement comprises a cylinder trunion mount 174 as best shown in FIGS. 26 and 27. The cylinder trunion mount 174 is provided at the forward or rod end of the cylinder barrel 175 of the hydraulic cylinder 120 in order to counterbalance the weight of the cylinder barrel 175 and extended cylinder rod at full hydraulic cylinder extension. The cylinder trunion mount 174 includes a collar 176 that surrounds the hydraulic cylinder barrel 175. A pair of stub shafts 178 protrudes from the collar 176 and is received in a pair of laterally spaced apart plates 180 that are supported on the ejector frame 122. This arrangement allows the hydraulic cylinder 120 to pivot up and down relative to the ejector blade 33. Additionally, the ejector blade 33 may rack or twist slightly side-to-side as it slides back and forth in the rear eject body 25 (e.g., less than an inch on either side of the ejector blade 33). To account for this movement, the cylinder mounting arrangement also has a vertical axis of rotation. In particular, as best shown in FIG. 27, the laterally spaced plates 180 to which the hydraulic cylinder 120 is mounted are connected at their rearward upper and lower ends to a respective pair of vertically extending pivots 182 that are supported on the ejector blade frame 122. These pivots 182 permit the hydraulic cylinder 120 (along with the laterally spaced plates 180) to rotate about a vertical axis defined by the two pivots 182. If the two pivots 182 are arranged so that the vertical axis of rotation is located at or near the neutral point of any side-to-side twisting of the ejector blade 33, side-to-side twisting of the hydraulic cylinder 120 is virtually eliminated. In this case, the vertical axis defined by the two pivots 182 is arranged at the rearward end of the hydraulic cylinder barrel. With this arrangement, the hydraulic cylinder 120 pulls on the ejector blade 33 as it extends or ejects the load in such a way as to produce a centering action on the ejector blade 33.

Details of the hydraulic control system are set forth in U.S. Pat. No. 7,326,023, which has been incorporated by reference herein.

It will be appreciated that the examples described herein are not intended for limitation, but rather, are provided for purposes of explanation. It will further be appreciated that the truck 10 may be loaded with any suitable combination of materials in any suitable ordered segmentation such that the order and segmentation is maintained in a layering of the load in the charge bucket 53. Therefore, it will be appreciated that the invention is not limited to scrap processing applications, but may be utilized in other applications where it is desired to maintain segmentation of material in a load during the process of transferring the load from a haulage vehicle.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of loading a charge bucket of a metal processing mill with scrap metal in which the scrap metal is sorted by types, the method comprising;
loading into a truck body a load of scrap metal, where the load is segmented into two or more types of the scrap metal distributed between a front and back of the truck body;
transporting the load of scrap metal to the charge bucket; and
ejecting the load of scrap metal from the truck and into the charge bucket by pushing the load along a floor of the truck body so that the segments of the load spill over a rear edge of the body in sequence and into the charge bucket, thereby transforming each of the segments into a layer of a type of the scrap metal contained by the charge bucket.

2. The method of claim 1 wherein a weight of the truck body load is monitored during the loading of the scrap metal into the truck body.

3. The method of claim 2 wherein each incremental increase in the weight of the truck body load is communicated to an operator of a loader that works to load the truck body in the scrap metal yard.

4. The method of claim 1 including transporting the charge bucket to a furnace of the metal-processing mill after the charge bucket receives the load ejected by the truck body and discharging the layered scrap metal from the charge bucket into the furnace.

5. The method of claim 1 wherein the transporting of the load of scrap metal to the charge bucket includes transporting the load to the charge bucket located within a melt shop of the metal processing mill.

6. The method of claim 1 wherein distribution of the segments of two or more types of the scrap metal comprising the load is in accordance with a recipe for loading the charge bucket with scrap metal.

7. In a rear eject body for a truck for receiving a load of scrap metal to be transferred to a charge bucket for a furnace of a metal mill, an ejector blade moving between retracted and extended positions for pushing the scrap metal out of the body and a tailgate for moving between open and closed positions, a method of transferring the load from the rear eject body to the charge bucket, the method comprising;
with the tailgate in the closed position and the ejector blade retracted, loading into the rear eject body different types of the scrap metal so as to segregate each type along a length of the body, where the segments are ordered along the length in accordance with a recipe for loading the charge bucket;
transporting the load comprising the segments of different types of scrap metal to a location of the charge bucket, where a top of the charge bucket is at an elevation below a floor of the rear eject body; and
ejecting the load of scrap metal from the rear eject body and into the charge bucket by moving the ejector blade from the retracted position to the extended position and moving the tailgate from the closed position to the open position so as to push the load along the rear eject body without any substantial mixing of the segments, allowing the segments of the load to individually spill over a rear edge of the rear eject body and into the charge bucket so that each segment redistributes itself in the charge bucket to form a layer of the type of scrap metal comprising the segment.

8. The method of claim 6 wherein the loading of the rear eject body includes monitoring a weight of the load.

9. The method of claim 8 including communicating the weight of the load held by the rear eject body to a loader operator for loading the rear eject body.

10. The method of claim 7 including transporting the layered load in the charge bucket from the location at which it was loaded to a furnace of the metal mill and discharging the layered load from the charge bucket into the furnace while maintaining the integrity of the layering.

11. The method of claim 7 wherein the location of the charge bucket is within the melt shop of the metal mill.

12. Using a rear eject body of a truck for loading scrap metal into a charge bucket for a furnace of a metal mill, a method of loading the charge bucket comprising an ejector blade moving between retracted and extended positions for pushing the scrap metal out of the body and a tailgate for moving between open and closed positions, a method of loading the charge bucket with the scrap metal, the method comprising:
loading the rear eject body with scrap metal so that different types of scrap metal are distributed along a floor of the body from front to back of the body in accordance with a recipe for layering types of scrap metal in the charge bucket;
transporting the loaded rear eject body to a charge bucket located within a melt shop of the metal mill;
moving an ejector blade of the rear eject body toward a rear edge of the body and in concert with opening the tailgate so as to eject the load of scrap metal into the charge bucket by spilling the scrap metal over the rear edge and into the charge bucket, thereby substantially maintaining the distribution of the different types of scrap metal loaded onto the rear eject body and reorienting the distribution from a substantially vertical distribution in the rear eject body to a layering of each type of scrap metal in the charge bucket such that an ordering of the layering conforms to the recipe for layering types of scrap metal in the charge bucket.

13. The method of claim 12 wherein a weight of the truck body load is monitored during the loading of the scrap metal into the truck body.

14. The method of claim 12 wherein each incremental increase in the weight of the truck body load is communicated to an operator of a loader that works to load the truck body.

15. The method of claim 12 including discharging the loaded charge bucket into the furnace by lifting the charge bucket to a position over an open top of the furnace and releasing the scrap metal from the charge bucket through a the bottom opening of the charge bucket.
